(19) United States
(12) Patent Application Publication
(10) Pub. No.: US 2026/0073376 A1
(43) Pub. Date: Mar. 12, 2026

(54) SYSTEM AND METHOD

(71) Applicant: Paul Damian Nelson, Melbourne (AU)

(72) Inventor: Paul Damian Nelson, Melbourne (AU)

(21) Appl. No.: 19/275,199

(22) Filed: Jul. 21, 2025

(30) Foreign Application Priority Data
Jul. 22, 2024 (AU) 2024902281

(51) Int. Cl. G06Q 20/28; G06Q 20/10

(52) U.S. Cl. CPC G06Q 20/28; G06Q 20/10

(57) ABSTRACT

Systems and methods are shown that include a method comprising one or more processors configured to perform operations including: a transaction system wherein value (v) is paid for by the advance (a) that is value less interest or discount (i) wherein the advance earns interest or discount leading to the delivery of the value by the advance and the interest or discount [v−i=a]. Better: price for the customer, and cash flow for supplier. In this way people in the world are helped to feel good energetically and are helped materially to feel good at the same time.

### CROSS-REFERENCE TO RELATED APPLICATIONS

This application claims priority of the Australian Provisional application 2024902281 dated 22 Jul. 2024. The present invention relates to a new system and method of payments or transactions to help a supplier always trade cash positive and to help a receiver operate in wealth and where poverty is over written by wealth.

### BACKGROUND TO THE INVENTION

Muhammad Yunus founded the Grameen Bank and is the pioneer of microcredit and microfinance. This is founded on his warmth and care for people. That lead to helping those in need, the greater community, and the world around us.

Pay day loans or advance payments against a person's pay are well known. A big problem with these is that they may take high interest and or require payment when the lender does not really have the money to pay. However this process shows the power of cash flow from the pay day lender and how that cash flow can really help someone in a squeeze.

It is well known that for a customer to buy goods from a shop they are normally paid for at the time of purchase which includes the customer receiving the goods.

It is also well known that when a customer buys goods online they are paid for and the goods shipped out at the earliest convenience from the time of purchase which may be for example within 1-5 days or something like that.

A problem with these conventional systems is when a customer wants a discount on the purchase price (even if there is already a discount taken into account) they can't get one. And that might put a customer off.

Another problem with this convention system is when the shop wants to obtain more cash flow, or cash flow sooner rather than later.

It is well known that an investor or payer can advance money as a loan for a business or entrepreneur with the hope of earning a good financial return. A problem with this is that a business may not be cash positive or really able to make loan repayments in the sense that the money is preferably needed to help make the business profitable first.

It is the object of this invention to overcome these problems and provide a new system and method of payments or transactions, to help the payment receiver and the system they are in be cash positive. Also it is the object to provide advantages to the payer to be looking ahead with finances and so paying ahead and to become accustomed to that generous implementation.

### SUMMARY OF THE INVENTION

The invention herein and all aspects of the invention are methods that can be implemented by the following systems (a) through (e):
a. A method performed by data processing apparatus, the method comprising:
b. A computer storage medium encoded with a computer program, the program comprising instructions that when executed by data processing apparatus cause the data processing apparatus to perform operations comprising:
c. A system comprising:
   i. A data store for storing content items; and
   ii. One or more processors configured to interact with the data store, the one or more processors being further configured to perform operations comprising:
d. A computer implemented method comprising:
   one or more processors configured to perform operations including:
e. A method comprising:
   one or more processors configured to perform operations including:

In a first aspect the present invention resides in a method comprising: one or more processors configured to perform operations including: a transaction system wherein value (v) is paid for by the advance (a) that is value less interest (i) wherein the advance earns interest leading to the delivery of the value by the advance and the interest

$$v - i = a$$

In a preferred embodiment of this aspect of the invention wherein for example

$$v - i = a$$

$300−$50=$250

In a preferred embodiment of this aspect of the invention wherein a first party advances funds to a second party as part payment for the value and wherein interest is either a lump sum or is earned from the advance wherein interest plus the advance equal the value wherein the second party provides the value or has the value provided then to the first party.

In a preferred embodiment of this aspect of the invention wherein the value can be in the form of goods or services, or money, or anything else suitable.

In a second aspect the present invention resides in a method comprising: one or more processors configured to perform operations including: a transaction system wherein value (v) is paid for by for the advance (a) plus interest (i) leading to the delivery of the value

$$a + i = v$$

In a preferred embodiment of this aspect of the invention wherein for example

$$a + i = v$$

$250+$50=$300

In a preferred embodiment of this aspect of the invention wherein the transaction system is part of a business, or store, or bank, or any other organization and where

$$a + i + n = v$$

$250+$50+$5=$305

$$a + i = v - n$$

$250+$50=$305−$5

In a preferred embodiment of this aspect of the invention wherein n is a number representing a fee or transaction fee.

In a third aspect the present invention resides in a method comprising: one or more processors configured to perform operations including: a payment system wherein an advance is made to a receiver to enable the receiver to only experience a profitable position with regard to the transaction which establishes wealth wherein the advance is to be settled with applicable interest only from a profitable position.

In a preferred embodiment of this aspect of the invention wherein a payer makes a payment in advance to a receiver who later settles the debt with applicable interest in the form of goods and or services or anything else suitable enabled by the advance.

In a preferred embodiment of this aspect of the invention wherein the system and method provider is paid a service fee in the form of a flat fee or a percentage for example 1%-3% of the profit after tax or revenue about equivalent to that obtained by the receiver.

In a preferred embodiment of this aspect of the invention wherein the receiver profit position includes wages or salary above the poverty line, and between US $5k-$25k pa, or between US $25k-$50k pa, or between US $50k-100k, or between US $100k-$150k.

In a preferred embodiment of this aspect of the invention wherein a web site or platform provides the facility for a person who provided an advance to a receiver to see and manage their account of one or more advances they made.

In a preferred embodiment of this aspect of the invention wherein the formula to ascertain the Advance Payment (A)=Settlement price (P) minus Interest (I) which is A=P−I.

In a preferred embodiment of this aspect of the invention wherein A=P−I is shown by way of example as A=P($300)−I($50)=$250.

In a preferred embodiment of this aspect of the invention wherein the payment is made in advance of any suitable time frame and for example is at least 3 months from when the goods and or services or anything else suitable is provided.

In a preferred embodiment of this aspect of the invention wherein the payment is made in advance on the basis of having any suitable interest and for example is around 1.5%-5% interest per month or at least 6%-10% interest per year, and where the interest is either simple interest or compound interest or anything else suitable.

In a preferred embodiment of this aspect of the invention wherein the payment system is a system and method of creating wealth or replacing poverty with wealth.

In a preferred embodiment of this aspect of the invention wherein the payment system is a bank or represents a bank.

In a preferred embodiment of this aspect of the invention wherein the receiver either already has a business or starts a new business where they use receiver funds to help it become profitable and where the receiver is the founder of the business.

In a preferred embodiment of this aspect of the invention wherein a payer makes a payment in advance to a receiver who later settles the debt with applicable interest in the form of money when the receiver is in a profitable position enabled by the advance.

In a preferred embodiment of this aspect of the invention wherein a web site or platform provides the facility for a receiver seeking an advance to make or post a profile seeking an advance and where the web site bank can make the advance or where investors can find a suitable receiver to invest their funds with via the web site.

In a preferred embodiment of this aspect of the invention wherein the payment system can be used across all financial status levels wherein the payment system is equal to be used across all status levels and wherein in that system there is no poverty from this method because the supplier only settles the debt when they are free to do so or from a profitable position which means by supplying goods and or services or by supply of money in return which is only from a cash positive or profitable position for the given transaction/s.

In a preferred embodiment of this aspect of the invention wherein there is no loan repayment schedule and instead there is a settlement payment from a suitable percentage of revenue or profit after tax, for example a maximum of 10% of revenue or 10% profit after tax, which is paid from the receiver to the payer in an ongoing basis until the advance and all applicable interest is paid.

In a preferred embodiment of this aspect of the invention wherein there is a loan repayment schedule that is used as a measure to obtain the funds from the receiver on the level of dedication and importance or gravity or discipline as a loan repayment or part repayment but where the funds do not make payment against a transaction or balance but rather are set aside and become savings for the receiver, so wherein this process is a new system and method of savings correlating to or corresponding to a loan repayment schedule.

In a preferred embodiment of this aspect of the invention wherein the payment system provides for advanced cash flow in the receiver business or personal life and wherein the settlement of that occurs when the supplier is free to settle the advance or debt or when the receiver is cash positive to be able to settle the advance or debt thereby providing for the receiver to not be in poverty or to not experience poverty from the transaction/s.

In a preferred embodiment of this aspect of the invention wherein any settlement or payment from profit is deemed to be part of profit sharing, and wherein preferably the profit is shared fairly which can be considered in proportion to the proportion of input investment by any related parties, and wherein the investment may be considered as purely money, or where the investment may be considered as money and any other input such as goodwill, sharing contacts, or anything else suitable.

In a fourth aspect the present invention resides in a method comprising: one or more processors configured to perform operations including: a transaction system wherein value (v) is paid for by for the advance (a) plus interest (i) leading to the delivery of the value

$$a + i = v$$

$$or$$

$$v - i = a$$

wherein the advance is paid to purchase a card or a virtual card;
wherein an amount of interest is added to the purchase price based on a period of time; and
wherein the card is a) provided to the customer in the future by a set date where interest has then been earned or b) provided to the customer upon purchase but where the card is set to be activated in the future by a set date when interest has been earned by then.

In a preferred embodiment of this aspect of the invention wherein the card is called the Before Pay Card or the Future Pay Way Card, a Gift Debit Card, a Gift Credit Card, a Local Debit Card, a Local Credit Card, or anything else suitable.

In a preferred embodiment of this aspect of the invention wherein the card purchase price earns simple interest over a period of time, or compound interest over a period of time, or any other form of interest, or based on any other suitable method.

In a preferred embodiment of this aspect of the invention wherein optionally an account can be set up and attached to the Card wherein the account acts like a bank account that earns interest on any suitable terms, and where money can be spent from the account, and where money can be withdrawn from the account, or where money can be deposited into the account.

In a preferred embodiment of this aspect of the invention wherein the card is a gift card, purchased at a discount, that can be used to its full value after a period of time, wherein for example the gift card cost $300 and is discounted to $250 and is purchased for $250 and wherein it is provided to the buyer by an agreed date in the future for example 6 months where the card has the full value of $300 that can be used to redeem value with a supplier such as a bank or shop, wherein that $300 includes $50 interest earned.

In a preferred embodiment of this aspect of the invention where the Card is like the cross between a gift card and a credit card or a debit card in that the Card is local to a supplier in that it can only be used in relation to a set supplier for example an Amazon and can only be used for the Amazon business.

In a preferred embodiment of this aspect of the invention wherein the Gift Credit Card is a localised credit card or localised debit card meaning that it is a credit card or debit card that is local to a provider in that it can be used to buy value such as goods and or services or money or anything else suitable from the provider from which issued the card or to which the card is designed for.

In a fifth aspect the present invention resides in a method comprising: one or more processors configured to perform operations including: a transaction system wherein value (v) is paid for by the advance (a) that is value less interest (i) or wherein advance (a)+interest (i)=value (v)

$$v - i = a$$

$$or$$

$$a + i = v$$

wherein the advance earns interest leading to the delivery of the value by the advance and the interest;
wherein the advance is provided by a customer of a bank to the bank to then invest;
or wherein the advance is provided by a bank to an entrepreneur;
wherein the advance is used to fund a business or entrepreneur; and
wherein the advance plus interest is repaid in a profit share system by funds made by the business or entrepreneur.

In a preferred embodiment of this aspect of the invention wherein the bank repayment schedule is a portion of the revenue of the business for example 10% of revenue wherein the portion of revenue is estimated to reasonably equate to a fair portion of profit after tax for example 10%-20%.

In a preferred embodiment of this aspect of the invention wherein the business repays the advance plus interest over any suitable time frame wherein the repayment is by way of profit share wherein funds that can be considered profit whether that is from business revenue or profit after tax, wherein the profit is shared by all parties who contributed to the investment that is the investor or supplier of the advance, such as the customer of the bank, and or the bank, and the business and entrepreneur.

In a sixth aspect the present invention resides in a method comprising: one or more processors configured to perform operations including:
a method of a local bank;
including a customer account attached to a business or supplier;
wherein funds are applied to the customer account that earns interest payable by the business or supplier; and
wherein the funds can be spent anywhere locally that is on anything suitable that the business can provide or that can be supplied by or on behalf of the business.

In a preferred embodiment of this aspect of the invention wherein for example the business or supplier is Amazon and wherein a customer of Amazon has an account with Amazon and deposits money into their Amazon bank account that earns interest on the basis of

$$a + i = v$$

$$or$$

$$v - i = a$$

and wherein the customer can spend their money in their Amazon bank account on any Amazon shops, products, or with any partners as approved by Amazon to receive payments from Amazon.

In a preferred embodiment of this aspect of the invention wherein the customer account can be any facility or system to hold money and deal with transactions for example an account, a credit note, a credit system, an account system, a Gift Card, a Debit Card, a Credit Card, a Local Debit Card, a Local Credit Card, or anything else suitable.

In a seventh aspect the present invention resides in a method comprising:
one or more processors configured to perform operations including:
a method of Pay Sys, as in a method of a payment system;
including a customer account with a business or supplier;
wherein funds are applied to the business or supplier customer account that earns interest or potential interest, or theoretical interest, or a discount, or right for one or more discounts, payable by the business or supplier;
wherein the business as the receiver of the funds can use the advance in the operations of the business; and
wherein the business or supplier settles the transaction in line with the method of

$$v = a + i$$

$$where$$

$$value ( v ) = advance ( a ) + interest or discount ( i )$$

by supplying to the customer goods and or services or money or anything else applicable.

In a preferred embodiment of this aspect of the invention wherein the business or receiver settles the transaction from resources first received in their business operations.

In a preferred embodiment of this aspect of the invention wherein the business or receiver makes its money or profit margin or operating margin from the sale of good and or services.

In a preferred embodiment of this aspect of the invention wherein the business or receiver settles the transaction with good and or services.

In a preferred embodiment of this aspect of the invention wherein the settlement of the transaction means the advance and the interest portion or potential interest portion, or theoretical interest portion, or discount portion, have been provided to the customer in the form of goods and or services or money or anything else suitable, which is preferably at a later date from when the advance was made.

In a preferred embodiment of this aspect of the invention wherein the payment system is a profit share system, in the sense that the business or operation settles the transaction from its operating function of selling goods and or services or anything else suitable, either from operations in general, or from operations to do with another transaction, or with the operation specifically related to the transaction with the specific customer.

In a preferred embodiment of this aspect of the invention wherein the payment system is a profit share system, in the sense that the business or operation settles the transaction from any financial position that is cash positive, wherein cash positive means the business or operation is not going into debt to settle the transaction.

In a preferred embodiment of this aspect of the invention wherein the payment system business settlement is paid not from business operating margin or profit but from any other source or combination of any other source and business operating margin or profit margin.

In a preferred embodiment of this aspect of the invention wherein the Pay Sys, or the payment system is in line with the following formulae

$$a + i = v$$

$$and or$$

$$v - i = a$$

In preferred embodiments of all aspects of the invention wherein known systems and methods, apparatuses, articles, items or things can be used to implement all aspects of the invention and all embodiments and preferred embodiments of the invention.

In preferred embodiments of all aspects of the invention wherein any combination or permutation of the elements and principles of design (as are known in the design industry) are used for any given embodiment, or any range of embodiments.

In preferred embodiments of all aspects of the invention wherein any combination or permutation of any number of claims can be made with any number of other claims, creating the definition of new claims.

In preferred embodiment of all aspects of the invention wherein the system and method as represented or described in any part of this specification.

In preferred embodiments of all aspects of the invention wherein the system and method as represented or described in any part of the figures or drawings.

### BRIEF DESCRIPTION OF THE DRAWINGS

FIG. 1 is a schematic diagram of an aspect of the invention;

FIG. 2 is a schematic diagram of an aspect of the invention;

FIG. 3 is a schematic diagram of an aspect of the invention;

FIG. 4 is a schematic diagram of an aspect of the invention;

FIG. 5 is a schematic diagram of an aspect of the invention;

FIG. 6 is a schematic diagram of an aspect of the invention;

FIG. 7 is a schematic diagram of an aspect of the invention;

FIG. 8 is a schematic diagram of an aspect of the invention;

FIG. 9 is a schematic diagram of an aspect of the invention; and

FIG. 10 is a schematic diagram of an aspect of the invention.

### DETAILED DESCRIPTION OF PREFERRED EMBODIMENTS

Below are “further definitions” of terms that are used in this document, where the definitions below are to be read as in addition to the definitions of the terms as accepted in the world around us, and in addition to the definitions as used in this document, and in addition to the definitions as used in the context of this document. These further definitions are:
a. “advance” means advance and includes a customer paying in advance for goods or services or anything else suitable whereby the advance earns interest in line with the formula

$$v - i = a$$

$$or$$

$$a + i = v$$

whereby the advance or balance of the customer account can include paying the business in full for particular goods or services or anything else suitable before the goods or services or anything else suitable is supplied to the customer for the balance, and whereby that can include the business receiving their profit margin up front or before they provide the goods or services or anything else suitable.
b. “account” means a local account in a business or in relation to a business. This account includes being a local bank account in that business where the account is held. This means when funds are applied to the account interest or the equivalent of that is earned and is added to the funds. The balance can be spent in the business on goods and or services or money or anything else suitable. In this way the account is a local bank account in the business and the business is the bank. Businesses that can have these accounts are any businesses in the world and include for example Amazon, Sainsbury's, Coles, the local baker, the local butcher, the local hardware store, or any other suitable business or organization. The specifications of the account can take any form. This can include any type of account known or used in banking or in relation to money. This means the customer account or account can be any facility or system to hold money and deal with transactions for example an account, a credit note, a credit system, an account system, a Gift Card, a Debit Card, a Credit Card, a Local Debit Card, a Local Credit Card, and so on.
c. “account system” means account system and means account and includes any facility that acts as an account or like an account for a customer to use in a local bank, or for a customer to use in a business. An account can include all the usual or normal things or conditions or specifications that an account or bank account or credit account has.
d. “advance” means paying in advance for anything where money is paid upfront before the final value or product is provided in exchange or return. This fosters trust and support, and hope. This goodwill fosters confidence and success. This leads to a settlement in the form of value that is a return of the advance with earned interest at a later date being provided by or on behalf of the supplier in the form of a settlement. The process of the advance shows the power of money being paid up front, and the power of money when used with timing, that is before the exchange of the value.
e. “bank” means bank and means a business or operation that can receive money and hold it or use it preferably to make more money. On the one extreme this includes any business or company that can do this, and on the other extreme this includes traditional banks. The word “bank” may have limiting connotations that are perceived as stopping or limiting how a business can be called a bank. For example, traditional banks do not supply goods or services in exchange for money a customer provides the bank to hold on to or use, in order to settle a transaction. Whereas in this document a business that does provide goods and or services in exchange for money is being called a bank because it provides the return of value of the money input by the customer together with what can be considered an interest portion, or a theoretical interest portion, or a potential interest portion, or a discount portion, or an added value portion, or what can be considered as any other definition to describe the final value that includes the original input amount plus an added component for taking into account the business being paid in advance for goods and or services or anything else suitable. In this sense the work “bank” is taken to mean “business” or “company” or “operation” or “generator” and anything else along these lines, or applicable. The word “bank” is used in a generic meaning and is not limited to the use of the word as used for any traditional bank or any commonly known bank. Accordingly a business or company or operation that is a bank but not a traditional bank does need to follow applicable business and company laws, regulations and rules, and accordingly not traditional bank laws, regulations or rules.
f. “Before Pay” means to pay an advance for something that is to be provided at a later date. This is to obtain a lower buy price that earns interest and where the advance helps the receiver cash flow personally or in business and where the settlement of transaction happens from a profitable position. This is based on v−i=a as in value (v) less discount or interest (i)=advance. Or a+i=v where advance (a) plus interest (i)=value (v).
g. “Before Pay Plus” means the same as Before Pay but also with the added focus on the benefits of paying in advance including having the interest component of adding value to the advance made by a customer.
h. “card” means the Before Pay or the Future Pay Way process, being able to be processed by the use of a Card that includes a virtual card acting like a card, or being a physical card, where the card is paid for by an advance (a) and interest (i) is added to that to bring the card to total value (v). Where

$$v - i = a$$

$$or$$

$$a + i = v$$

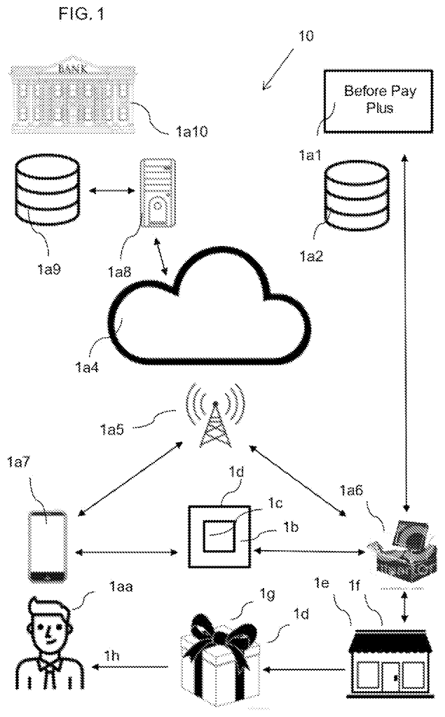

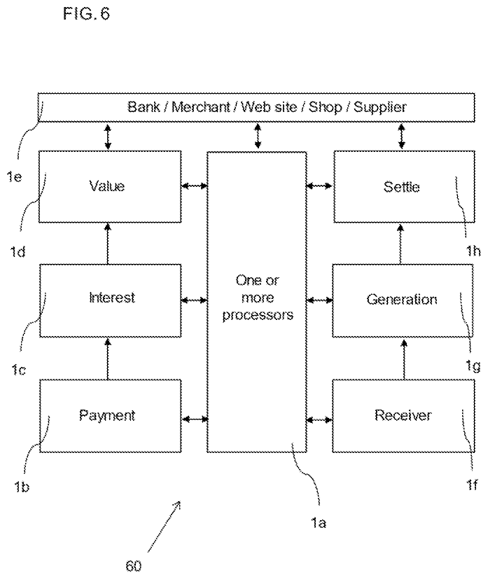

The interest is added in a period of time. The card is then used to buy goods and or services or money or anything else suitable in a store to the maximum value. The card can also be recharged. The card can be attached to an account or the card can be a stand-alone card without the need for an account. Like the way a gift card can be used. This can also be called a: Module, Loaded Card, Separate Card, Stacked Card, Pre Card, Pre On Card, On Card, On Guard, The Already Card, Pre Interest Card, Clean Card, Right Card, Pointed Card, Rounded Card, Gift Card, Debit Card, Credit Card.
i. “credit note” means a credit note and includes a system of an account by way of keeping a log or running balance of funds applied, interest earned, money spent, and anything else relevant. This can include scanning inputs of data or applying manual inputs of data to a record book, and or a computer file so as to keep track of things, and so that the account works well.
j. “discount” means discount and means an amount that is taken off the final value for any reason, which can include being a portion in exchange for advance payment for the value of goods and or services or anything else applicable. The amount taken off the value total or the discount can also be described from another perspective, or as another method, as equivalent to interest, or as interest on the advance, or interest earned on the advance, or potential interest on the advance, or theoretical interest, or potential discount, or effective discount, or any description applied to the final value rather than the advance, or any description applied to the advance and the final value, a combination of both, or anything else suitable. This is in line with the Pay Sys formulae, or the payment system formulae

$$v - i = a$$

$$and or$$

$$a + i = v$$

Where v=value, or total value, being the final value of goods and or services or anything else suitable
   Where i=interest or interest earned, or potential interest, or theoretical interest, as equivalent to, or separately as discount, or discount for the total of the value, or discount because of the advance including over time.
   Alternative words with their corresponding definitions, or interchangeable words with their corresponding definitions for “interest” and “discount” include component, portion, part, amount, quantum, quantity, consideration, payment, acceptance, pay, reduce, reduction, reward, loyalty, prize, award, added value, bonus, gift, earn, earning, or anything else along these lines, or anything else applicable.
   This discount definition applies to all “i” (in formula form) and “interest” definitions in this document. This discount definition applies to item 1c in all of the drawings.
k. “drawings” in FIGS. 1-5 items 1a1-1a10 correspond to 1a in FIG. 6.
I. “drawings” items 1a1 Before Pay or Future Pay Way is a method and a computer implemented method that can implemented by any known or suitable system/s where 1a2 and 1a3 can be part of a single computer 1a2 and 1a3 with a program running 1a1 the foundation formula

$$v - i = a$$

$$or$$

$$a + i = v$$

for example as part of or connected to a web site, a store, a bank, etc, or 1a1 can be part of any amount of processors with a store such as a server 1a2 with a store 1a3, for example as part of or connected to a web site, a store, a bank, etc.
m. “data processing apparatus” means any apparatus that can process data, including one or more processors, including any data processing system, including data processing units or DPUs, and includes any apparatus for any system and method including any computer implemented method or computer implemented system, and or any apparatus for any other computing related system.
n. “formula” means formula and means economic formula or economic system or Future Pay Way formula or payment system or transaction system and is represented by

$$v - i = a$$

$$or$$

$$a + i = v$$

whereby a customer pays in advance (a) to a business for goods or services or money or anything else suitable and where the advance earns interest (i) and where the advance (a) plus the interest (i) combine to form the total the value (v) amount that can be used in the business to buy goods or services or anything else suitable. This business the advance (a) is provided to can be considered a local bank. The business or the local bank makes an operating profit and it can a) not pass on any of that profit to the customer and therefore not be involved in profit sharing or b) pass on some of the operating profit or equivalent to that to the customer for some or all of the interest (i) component and in which case this would be considered profit sharing.
o. “Future Pay Way” means Future Pay Way and means Before Pay and Before Pay Plus and vice versa. This can also be called Payment System, The Payment System, Pay Sys, pay sys, or anything else suitable. This includes methods, systems, processes, applications, programs, and anything else suitable to implement the method of a local bank or the method of a local bank account. The approach and action of this system and method is to help people feel good by providing a system and method that helps makes that happen. This is whereby a customer has a local account with a business. The customer account earns interest payable by the business or the local bank. The customer bank balance which includes the advance plus interest can be spent on goods or services or anything else suitable from the business or its affiliates. In this the provider or supplier pays an interest portion to the customer account based on the customer advance or even where the supplier pays a healthy interest portion based on an advance from a customer but preferably where the interest payment by the business is lower than the business or the supplier or provider makes in their business or operations so they are trading in profit. And where preferably the customer makes a sizable better interest portion than traditional banks pay. And where the value can be exchanged by goods and or services or money. And being backed or secured by that. Making this a new form of bank. Also the future way to pay way. This is a transaction system. This is a banking system. This is a community spirit. This is people grounded in the earth. This is people in business grounded in the earth. This is people trusting in people.
p. “Future Pay Way method” means the Future Pay Way method, and includes Future Pay Way, that includes solving the system of poverty by providing the system of positive cash flow where payment is made in advance for goods or services or anything else suitable via a local bank account. Where the advance earns interest. Where the advance plus interest create the value amount. Where the value amount can be spent in the local bank to which the account is held or related to. Where the advance improves the cash flow of the business also called the local bank. Optionally where the business and the customer share in the profit of the business. Optionally where the supplier of the goods or services or anything else suitable share in the profit with the business and the customer. By providing the system of cooperation and alignment. This creates the Future Pay Way system where each person benefit and where the overall system benefits due to sustainability and positive growth all the while adding positive value to the society and the world around us. This Future Pay Way method is designed to help people feel good, to feel better both individually and in their community. This Future Pay Way method is designed to help people feel good, to feel better by providing material support with positive financial systems and being connected to an overall system where the parties involved are in alignment and on the same page. This creates a sense of purpose and belonging and positive value both in the current system and the world around us.
q. “Future Pay Way 1a1 system integrated” means Future Pay Way integrated and includes the system of Future Pay Way integrated into a business or web site where there is no need for a separate server or separate system because it is integrated into the business system. This means it is integrated into the operating system. This can be by way of a program, an app or any other suitable system.
r. “goods or services” means goods or services and includes anything suitable for example where goods or services or anything else suitable are paid for from an account or where goods or services or anything else suitable includes money that can be withdrawn from an account or money that can be made from the account or funds from account.
s. “goods or services or money” means goods or services or money and includes anything suitable for example where a customer has an account that has funds that can pay for goods or services or where the funds can make money for example from interest earned and where the customer can withdraw that in cash. Also if suitable the customer can use the account funds to make money by for example by FOREX trading and anything else suitable.
t. “interest” means interest and means interest in any form, including interest earned, or potential interest, or theoretical interest, or discount, or equivalent to that, or anything else suitable. Interest can be based on the advance by the customer, or it can be based on the value of the goods and or services or anything else suitable, or it can be based on the profit margin or operating margin the business makes. In other embodiments the interest or discount portion can come from any source or any way. In this sense a customer can be paid in goods or services or anything else suitable for their advance together with interest, or discount on the value of the goods and or services or anything else suitable, where the discount amount (which can be considered as equivalent to a theoretical interest amount, or actual interest amount in other cases) is paid from the business profit margin by trading their goods or services in general, and or for the specific purchase relating to the customer in a given example.
u. ‘local” means local and includes a customer having an account with a business or organization that acts as a bank whereby that bank is the supplier of goods and or services or anything else suitable from the customer spending money from their account. As the bank is the supplier of the interest on the account and the supplier of the goods and services or anything else suitable then the bank account is considered local to that bank. This also means where the bank account is not local to another business in the sense that the account does not entitle the customer to buy or redeem goods or services or anything else suitable from a business that is not related to the local bank.
v. “local bank” means local and means bank and means local bank and includes a business or number of businesses related to each other whereby the business supplies goods or services or money or anything else suitable to a customer who has an account that has funds in it that earn interest payable by the local bank, where the customer does buy locally from the business or its affiliates. In general preferably the local bank would pay higher interest than traditional banks and the local bank would make a higher margin from its usual sales or running of its business than the margin it pays out as interest to its customers on account. In this way the local bank is sustainable and a cooperative system between the customer, the bank, and the supplier/s. This is the Future Pay Way system. The businesses as described in relation FIGS. 1-10 are local banks where the customer accounts in those are local banks accounts. The method of a local bank replaces the system of poverty with the system of sustainability or wealth.
w. “local bank account” means a local bank account and includes an account that a customer has with a business or in relation to a business where the funds on account earns interest and whereby the funds in or from the account can only be spent locally that is being spent in the business where the account is or in any other business that is approved to receive payments in relation to the original business. The accounts described in relation FIGS. 1-10 are local bank accounts where the supplier or the business where the account his held is the bank.
x. “one or more processors” means any number processors, of any type, used by any system, or any number of systems, including classical computing, or AI, artificial intelligence, or any other system or systems, and including of the following processors, that can operate separately, related or simultaneously: including a machine that processes something, including having a central processing unit, in a relation to a single computer; and or in relation to any number of computers; and or in relation to any number of servers or similar systems; and or in relation to any applicable computing system hardware, software or firmware; and or any applicable type and number of data processing apparatus; and optionally where any of these systems and methods are connected to the internet, and or operate on the internet or in any other environment.
y. “payment” means to provide funds or cash from one party to another where the exchange of value such as goods or services for the payment can happen at any time.
z. “POS” or “point of sale” means the point that a payment or transaction can be made to buy goods or services, and includes an account or transaction account, and the location or point of transaction of a transfer of funds from one party to another party.
aa. “potential interest” means potential interest and means the process by which a theoretical amount of interest can be applied, or will be applied, or is applied. Potential interest in one form is theoretical interest being an amount equivalent to an interest portion that is not real interest, or actualized interest, but which can become real, or that can equate to any other form and as a result have any suitable definition accordingly. One such example is where theoretical interest is defined as a discount rather than interest earned. It is called potential because the advance payment may not actually earn any interest, and in some examples the advance does not earn any interest. However, there is value in a customer paying an advance to a business, in terms of supporting the business, helping with cash flow, and providing the function in generating profit margin, or margin. And it could be said there is latent value in such a transaction. In this case, where the advance is made, the business makes a profit margin in their normal operations of selling goods and or services, which can be helped by the advance from a given customer, and so the business in return passes on some of that profit margin to the customer in this example. So the potential interest is a discount on the value of the good and or services. Or it can be described that the discount is a theoretical amount of interest, or an amount equivalent to an amount of interest, based on the advance over time, or based on the final value, over time or not, whether that be considered interest or not. The potential interest can equate to the interest payment paid by the business to the customer to settle the advance payment. In this case even though the payment is settled the interest component can still be considered as potential interest, when for example it is considered a discount. In other examples, the potential interest becomes recognized as actual interest when it is paid. These descriptions are in line with the financial payment system formulae

$$v - i = a$$

$$and or$$

$$a + i = v$$

Where v=value, or total value, being the final value of goods and or services or anything else suitable
   Where i=interest or interest earned, or potential interest, or theoretical interest, as equivalent to, or separately as discount, or discount for the total of the value, or discount because of the advance including over time.
bb. “product” or “products” means value, total value, settlement value, of goods and or services, money, or anything else.
cc. “profit” means profit, or profit after tax, or operating in a good position, or operating in a cash positive position, or operating in the green, or the system where a portion of revenue is used so as to put a stake in the ground based on cash flow before tax documents are finished, or where a portion of revenue is deemed to be an equivalent to what could equate to profit after tax, for example 1-20% of revenue could be estimated to be equivalent to potential future 2-50% profit after tax, or any other suitable figures could be used.
dd. “profit share” or “profit sharing” means profit sharing. And means paying from a profitable position. This includes a customer paying in advance for goods or services or anything else suitable where the receiver of the funds obtains a profit margin in advance of supplying the goods or services or anything else suitable. And means of profit made or equivalent profit made or expected to be made that is shared between any amount of parties. This can include profit sharing where a business makes an operating margin and passes on some of that margin or equivalent to that to a customer to pay the interest on the customer advance or account balance. Profit can be shared equally or unequally. Preferably the profit is shared fairly. That can include the where input proportion by the parties involved is the same as the output proportion. So for example if there are three parties who input $1k each, and there was realized $6k profit, then they would profit share by receiving $2k each. That means proportion of input is ⅓:⅓:⅓ and the output proportion is ⅓:⅓:⅓. This creates harmony and sustainability for the people involved, the community, and the world around us. This means there is no poverty able to take hold in this system. Input value can include money and or any other value such as contacts and goodwill. Any other suitable figures or terms can be used in other examples. For example input proportion may be ½:¼:¼ and the output proportion maybe ⅕:⅕:⅗.
ee. “supplier” means any person or business or organisation that can provide something, which includes a bank, a store, a shop, a retailer, a wholesaler, a manufacturer or any other party in the supply chain.
ff. “supply” means the right of a party to have an advance and any applicable interest that combine to become the value, supplied in goods and or services or money at the choice of the customer and or the supplier. The timeframe for the supply is as agreed on the advance stage or at any other stage.
gg. “system and method” means system and method and in respect of this invention and all its aspects of the invention it is preferable to add good value to the world, to help people feel good, by providing good to the world that flows through to the people helping them to feel good while helping them in a positive material way at the same time.
hh. “traditional bank” means traditional bank and means institutions that are traditionally called a bank, or officially called a bank. Some examples are ANZ, NAB, Westpac and Citi or Citibank and so on. A traditional bank is known to follow the relevant banking laws, regulations and rules. In this document a local bank is not a traditional bank. This is because a local bank herein is generally a business that accepts an advance from a customer, where the business (the local bank) provides in return goods and or services or anything suitable along with a discount portion, or an interest portion, or potential interest portion, to settle the transaction. In this process the settlement comes locally that is from the local supplier, as in the supplier related to the receiver of the advance. In this document a traditional bank is not a local bank. This is generally because a traditional bank does not settle a transaction with goods and or services. This is also generally because a traditional bank does not settle the transaction from a profit share position, which can include from a profit margin or an operating margin. There can be in the world a local traditional bank but that is not what is defined here as a local bank under this patent. An example of a local traditional bank could be the Bendigo Bank. The one snapping at the heels of the big four.
ii. “value” means anything of value in exchange for the payment, or as part of the transaction system of Before Pay, or Future Pay Way, including for example goods or services, money, or anything else suitable.

FIG. 1 shows a system and method 10 of the Before Pay Plus 1a1 system and method including a program or software with a data store 1a2 that are both connected to and processed by the store 1e Point of Sale (POS) system 1a6. In an alternate embodiment the Before Pay Plus 1a1 system is run and processed by one or more processors with a server connected to the internet 1a4 and where the system 1a1 has a data store 1a2. The Before Pay Plus 1a1 system includes a program for a store 1e at the POS 1a6 to enter input and receive output. The basic input options includes the value price which is the buy price 1d, and the interest amount 1c, and the duration of the advance before the store settles the transaction 1h. Any other suitable content can also be entered and processed. This forms the fundamental formula for the Before Pay Plus 1a1 system as value (V)=advance (A)+interest (I) that is V=A+I. The interest part can be a lump sum or be calculated with an interest rate for example 1%-5% simple interest, or compound interest, per month. Or an interest amount per year. The customer 1aa with their mobile 1a7 or smart phone, or laptop, or desktop, or any other suitable computing device 1a7 goes online via Wi-Fi 1a5 connected to the internet network 1a4 that is connected to the store 1e and chooses a product 1d to purchase. At the POS the product buy price or value 1d is presented. There is the option to purchase it with this Before Pay Plus 1a1 system. With the Before Pay Plus system and method 1a1 the customer 1aa sees V=A+I and also as (V) value price 1d−(I) interest 1c=(A) advance price with date of settlement 1h. This means there is a discount created by the interest portion 1c to be deducted from the buy price or value 1d when buying with this process of pay now get later in the Before Pay Plus system and method 1a1. The customer 1aa accepts that and pays the advance payment 1b with their credit card to a supplier 1e who is the receiver 1f of the payment 1b wherein the advance payment 1b earns interest 1c over a period of time that combine with the advance payment 1b to form the value price 1d. With the payment transaction 1b the customer 1aa enters their mobile number and or email address as a unique identifier or customer identification (ID), along with shipping or collection arrangements when the product 1d is right to be provided at a later date to the customer 1aa. With the advance 1b paid a receipt is sent by text and or email to the customer 1aa and or to the Before Pay 1a1 account system. The receipt includes at least the store ID 1e such as name and contact details, the date, the time, the product name 1d, the value of 1d, the advance amount 1b, the interest portion 1c, duration interest will be earnt, the date of settlement 1h and form of providing the product 1d for example by shipping or collection in person 1h. The decreased price of the advance 1b versus the value 1d is a benefit to the customer who saves some money 1c, and who is happy to pay now and get later 1a1 with this Before Pay system 1a1. The increased cash flow of the supplier 1e is a benefit to the store 1e which allows them to more easily and freely generate 1g the product from a profitable position 1g, for example buying the product 1d in with the advance payment 1b provided first, and then settle 1h the transaction 1b by providing the goods or services to the customer 1aa at a later date as arranged 1h. In this way the store 1e with this transaction system 1a1 is always trading in profit and never at a deficit and can be considered that they do not buy the product 1d and on sell to the customer 1aa. Rather, the store 1e gets paid as a manager store 1e to buy the product for the customer 1aa. Also connected to the internet network 1a4 is a financial service provider processing device 1a8 with a data store 1a9 being part of a bank 1a10 that can receive funds for the store 1e.

FIG. 1 system and method 10 will be further described by way of example. A customer 1aa by the name Where Ware with their mobile phone 1a7 walks into a hardware store 1e and goes shopping. The mobile is connected by Wi-Fi 1a5 to the internet 1a4. Ware finds a tool kit to buy 1d well stocked with Sidchrome. It costs $1,200 1d. Ware goes to checkout with the product 1d where the cashier scans the product with the POS scanner and all details of the product 1d come up on the POS computer 1a6. Ware is offered to pay by Before Pay Plus 1a1 that is a system and method represented by an application on the POS system that is connected online via cable to a Wi-Fi unit 1a5 connected to the internet 1a4. Ware asks how it works. The cashier says “do you want to see the price if you pay in advance by 6 months and earn interest with that?” Ware say “ok”. The cashier uses the POS to enter data into the Before Pay 1a1 system. It works off the basis (V) value−(I) interest=(A) advance that is V−I=A. The data input asks for the value 1d which is input as $1,200 1d and the interest 1c which is 15% in 12 months which is $180 which is $90 in six months. The output is the advance amount of $1,200 (V)−$90 (I)=$1,110 (A). Ware agrees as he likes the discount 1c on the product 1d. As preparation for the transaction 1a6 Ware is asked for his name, and mobile number or email 1a6. He gives his name and mobile number. He is also asked if he wants to pick up or have the product 1d shipped in 6 months as the settlement 1h. Ware agrees to come in a do the pickup. The cashier enters the data in the POS of the customer name, pick up date. Ware makes the payment 1b of $1,110 as the advance 1b using his mobile phone 1a7 credit card system app and the POS 1a6. Ware then receives a receipt on his mobile of the purchase 1b by Before Pay 1a1 at the hardware store 1e. The store uses the advance 1b to buy in the chosen product 1d so as to only operate from a position of profit and where the store 1e is not the owner of the product 1d but rather the manager 1e for customer 1aa of that. There is a bank 1a10 including a processing system 1a8 with a data store 1a9 that are connected to the internet 1a4 where the bank is a receiver of funds in the form of the advance 1b for the store 1e. The store 1e makes more money and profit from the sale of the product 1d at settlement 1h than they spend on the Before Pay 1a1 system of paying interest 1c to the customer 1aa. 6 months later Ware goes to the store 1e and picks up his Sidchrome set 1d as the settlement 1h of the advance 1b and interest earned 1c over the term of 6 months. In this way Ware is a happy customer 1aa getting great product with a lower price 1b but where the store 1e never had to give a discount 1c as what appears to be a discount 1c is interest earned. By not giving a discount the store 1e can hold a higher value in the product, communications and goodwill. And the store 1e gets a loyal and committed customer 1aa and the store 1e gets increased cash flow where they generated profit 1g of the product 1d from a profitable position.

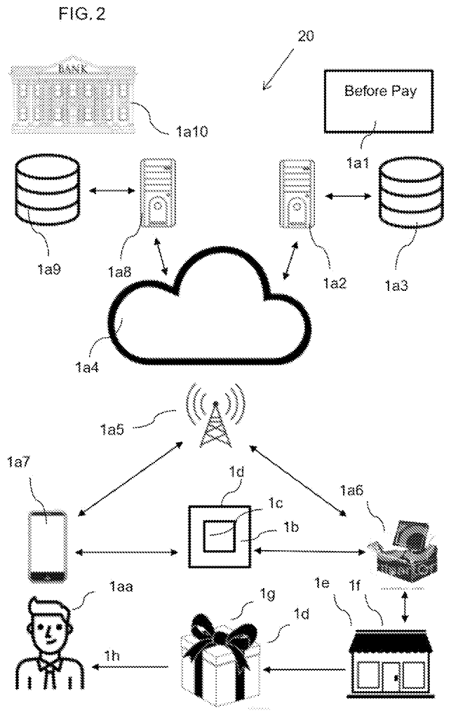

FIG. 2 shows a system and method 20 of the Before Pay 1a1 system and method including a processing system of one or more processors 1a2 with a data store 1a3. The Before Pay system 1a1 is connected to the network of the internet 1a4. The Before Pay Plus 1a1 system includes a program or app on a store 1e POS 1a6 wherein the app allows a user to enter input and receive output. The basic input options includes the value price which is the buy price 1d, and the interest amount 1c, which provides for an output of advance price 1b. Also optionally to be entered is an interest calculation which includes either a lump sum or an interest percentage over time before the store settles the transaction 1h. Any other suitable content can also be entered and processed. This forms the fundamental formula for the Before Pay 1a1 system as value (V)=advance (A)+interest (I) that is V=A+I. The interest part can be a lump sum or be calculated with an interest rate for example 1%-5% simple interest, or compound interest, per month. Or an interest amount per year. The customer 1aa with their mobile 1a7 or smart phone, or laptop, or desktop, or any other suitable computing device 1a7 goes online via Wi-Fi 1a5 connected to the internet network 1a4 that is connected to the store 1e and chooses to use the Before Pay system 1a1. The customer 1aa via their computing device 1a7 connected to the internet 1a4 and the Before Pay 1a1 web site sets up an account with as a client of Before Pay 1a1 by entering an email address or phone number as an ID, and a password. The customer 1aa shops online at the store 1e to get an idea of pricing and decides on providing a credit 1b to the store 1e for no particular product 1d on the basis the product or service will be chosen by the customer 1aa at a later date such as the settlement time 1h. In this way the advance 1b amount could buy a product 1d the customer 1aa saw which is used as a benchmark price 1d, and chooses to advance the store 1e with an advance 1b to redeem later with interest by a settlement of goods and or services to be specifically chosen later 1h. At the POS the product buy price or value 1d is presented as well as the term of the advance and the interest part 1c to be deducted from 1d. The customer 1aa accepts that and pays the advance payment 1b with their credit card to the supplier 1e who is the receiver 1f of the payment 1b. With the payment transaction 1b the customer 1aa enters their mobile number and or email address as a unique identifier or customer identification (ID), along with shipping or collection arrangements when the product 1d is right to be provided at a later date to the customer 1aa. The supplier 1e POS has the Before Pay app 1a1 that stores the customer 1aa data from the sale 1b. The customer 1aa can log onto their Before Pay 1a1 account and see a dashboard of their purchases including: the supplier 1e, optional choice of product 1d, settlement terms, and or simply credit on account and interest that is earning. With the advance 1b paid a receipt is sent by text and or email to the customer 1aa. The receipt includes at least the supplier ID 1e such as name and contact details, the date, the time, the product name 1d or credit amount if no set product is chosen at the time of making the advance, the value of 1d, the advance amount 1b, the interest portion 1c, duration interest will be earnt, the date of settlement 1h and form of providing the product 1d for example by shipping or collection in person 1h. The decreased price 1c of the advance 1b versus the value 1d is a benefit to the customer who saves some money 1c, and who is happy to pay now and get later 1a1 with this Before Pay system 1a1. The increased cash flow of the supplier 1e is a benefit to the supplier 1e which allows them to more easily and freely generate 1g the product from a profitable position 1g, for example buying the product 1d or other products 1d with the advance payment 1b provided first, and then settle 1h the transaction 1b by providing the goods or services to the customer 1aa at a later date as arranged 1h. With a floating credit on account 1b with the supplier 1e the term for settlement can be any length of time, but for example can be fixed 3-6 months. So the supplier 1e does not have to keep paying interest past that set time frame of the settlement period 1h. For example a customer 1aa by the name of Taylor 1aa can log onto their Before Pay 1a1 account and see on their dashboard advances 1b made, to who 1e, interest 1c, and anything else important. In this way the supplier 1e with this transaction system 1a1 is always trading in profit and never at a deficit from this method and can be considered that they do not buy the product 1d and on sell to the customer 1aa. Rather, the store 1e gets paid as a manager supplier 1e to buy the product for the customer 1aa. Also connected to the internet network 1a4 is a financial service provider processing device 1a8 with a data store 1a9 being part of a bank 1a10 that can receive funds for the store 1e.

FIG. 2 system and method 20 will be further described by way of example. The famous French fashion brand Chanel 1e has physical stores 1e and online stores 1e. Via their web site 1e a customer 1aa can set up an account 1a6 as a transaction account 1a6. A customer 1aa does that by using a unique mobile number and or email address and password. A customer 1aa by the name of Taylor Fit uses the mobile 1a7 connected with mobile broadband 1a5 to the internet 1a4 that is connected to a Chanel web site 1e and sets up their personal account 1a6 as a POS or transaction part in that account. Taylor 1aa sees that Chanel has Before Pay 1a1 on the web site 1e. With that there is a brief description of Before Pay 1a1 indicating to pay now 1b, earn interest 1c, and get delivery later 1h. Before Pay 1a1 is a system and method 1a1 with a processing apparatus or server 1a2 and a data store 1a3. Taylor 1aa clicks on the Before Pay 1a1 logo and also sets up an account for that in the same way as setting up and account 1a6 with the Chanel store web site 1e. Taylor 1aa browses online and as expected sees some wonderful things to buy 1d. This includes perfume and clothes 1d. As a benchmark the cost comes at around $17,500 for the things Taylor 1aa would like to buy. While in Taylor's account 1a6 there is a transaction section allowing for Before Pay 1a1 calculations. These are Buy Price (Value)−Interest=Advance cost. Taylor inserts the estimated value as $20,000 1d. The interest rate is showing as 10% per year which is $2,000 in 12 months 1c or $1,000 in 6 months 1c. Taylor has the option of either. Taylor chooses 12 months. So the buy price is $20,000 1d−Interest $2,000=$18,000 1b. Taylor pays that $18,000 1b with the credit card in the transaction account 1a6 as a POS system. The funds 1b go through to the store 1e as the receiver 1f and then to the bank 1a10 with its processing system 1a8 and data store 1a9. Taylor 1aa has not decided on what things to settle on 1h as after the 12 months when the credit is $20,000 1d Taylor 1aa can decide on what to buy then. So this is a rolling credit system 1a6 of Before Pay 1a1. The beauty is that the customer is really looking forward to buy their special things 1d. And Chanel 1e has freer cash flow to operate its business 1e not because they need to money but because it provides for more flowing profit 1g in supplying the products 1d when they are chosen as the settlement 1h in 12 months or later. A great relationship of cooperation between the customer 1aa and the store 1e is nurtured and supported with this welcoming and advantageous system and method 20.

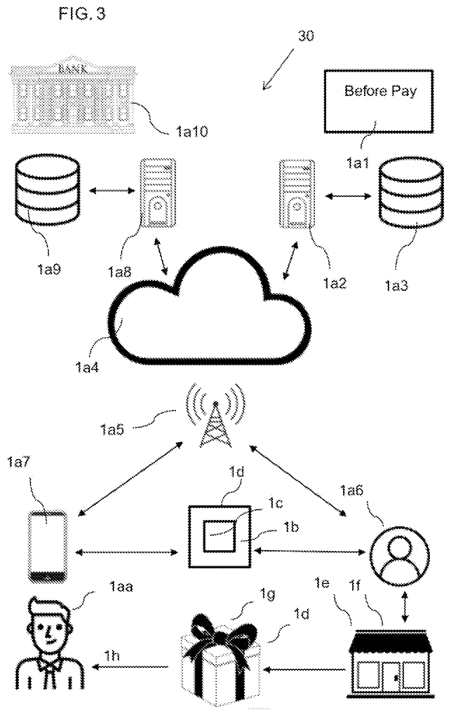

FIG. 3 shows a system and method 30 of the Before Pay 1a1 system and method including a processing system of one or more processors including a server 1a2 with a data store 1a3. The Before Pay system 1a1 is connected to the network of the internet 1a4. The Before Pay 1a1 system optionally includes a program or app with a supplier 1e that integrates with the POS 1a6 which includes a customer 1aa account where financial transactions take place 1a6 and optionally where there is a record of those for the customer 1aa. In an alternative embodiment the Before Pay 1a1 system includes an app or program with the supplier 1e POS or web site with or without there being a Before Pay 1a1 server 1a2 and store 1a3. The Before Pay 1a6 program or app can be one provided by Before Pay 1a6 or one as integrated by the supplier 1e that appears generic. The customer 1aa account is set up by providing a unique ID such as a mobile number and or email address, as well as a password, which are used to log into the transaction account 1a6. The account 1a6 allows for normal or conventional shopping and also has the Before Pay 1a1 system and method in the account 1a6 that includes the system of V=A+I that is Value=Advance+Interest. The customer 1aa with their mobile 1a7 or smart phone, or laptop, or desktop, or any other suitable computing device 1a7 goes online via Wi-Fi 1a5 connected to the internet network 1a4 that is connected to the supplier 1e and logs into their transaction account 1a6. The customer 1aa sees in their account 1a6 section that the Before Pay 1a1 system is Advance+Interest=Value. There can be any suitable interest used, and for any suitable term. The customer 1aa decides to add credit to their account by an advance 1b that can earn interest 1c which the customer 1aa can use to buy products or services 1d at a later date. So for example the customer 1aa pays to the receiver of the supplier 1e an advance of $300 1b onto their account 1a6 at the POS being their transaction account 1a6 at 5% simple interest per month with the plan of it sitting there for 12 months. In this example the interest does not continue past the 12 months so as to prompt the customer 1aa to spend the money 1d of value and for the Before Pay 1a1 system to stay in fair balance between the supplier 1e and the customer 1aa. That's $15 interest per month 1c. In six months the credit is $390 1d. In 12 months the credit is $480 1d. In this case the function V=A+I is (V) $480 1d=(A) $300+1b (I) $180 1c. The customer 1aa account shows a running balance of credit on account 1a6 that can be spent at any time with the supplier 1e on product or services 1d as generated 1g by the supplier 1e. When the customer 1aa pays on account 1a6 as credit shopping and purchases of products of services 1d can be made so that product 1d is delivered from the supplier 1e at the time of purchase. Alternatively, the customer 1aa also can choose to shop with the supplier 1e at any time and select one or more products 1d and receive the goods later 1h, wherein there will be interest 1c earned on the advance 1b based on the term between the time of the advance 1b and the time of the selection of product 1d to buy and delivery of product 1d that is the settlement 1h of the transaction or transactions. Also connected to the internet network 1a4 is a financial service provider processing device 1a8 with a data store 1a9 being part of a bank 1a10 that can receive funds for the supplier 1e. With the current example, the customer 1aa after 12 months has a balance of account of $480. The customer 1aa while logged into their account 1a6 on the store goes shopping and spends the $480 on all manner of things 1d. These are arranged to be settled at the time of purchase 1h and so to be shipped to the customer 1aa in normal time frames for example 1-5 days. In this way the customer 1aa gets the great advantage of having a discount of $180 by earning interest 1c on their advance for their purchases. Also where the customers is paying ahead and feeling calm and in control of their finances. Also the supplier 1e has the great advantage of having a committed loyal customer 1aa and of getting increased cash flow to use on their business 1e to generate 1g the products from a profitable position 1g. As a result this system and method 1a1 promotes wealth and can help a customer in poverty to come out of poverty by this method not creating any poverty by this process and wonderful experience of abundance and cooperation between the customer 1aa and the supplier 1e.

FIG. 3 system and method 30 will be further described by way of example. Sainsbury's the renowned UK supermarket 1e has physical stores 1e and online stores 1e. A customer 1aa by the name of Whole Some uses their mobile 1a7 connected with mobile broadband 1a5 to the internet 1a4 that is connected to a Sainsbury's web site 1e and sets up their Sainsbury's personal account 1a6 with a POS or transaction part in that account. That is done in the usual way of forming an account that is with a username and password 1a6. Whole 1aa did that because he saw it advertised that Sainsbury's has Before Pay 1a1. The Before Pay 1a1 is a system and method 1a1 integrated in the Sainsbury's web site 1e. Also or optionally alternatively there is a separate Before Pay 1a1 system with one or more processors 1a2 and a data store 1a3 to run the Before Pay 1a1 system. The Before Pay 1a1 system is based on the simple method of V−I=A or value 1d−interest 1c=advance 1b. Whole has a good idea about how much different products cost 1d and that $500 (USD) goes quickly. Whole looks at the account POS transaction area 1a6 and sees option to input value 1d for Before Pay 1a1 as credit on account 1a6 in order to show savings made 1c or interest earned 1c. The system 1a6 shows interest of 10% per annum 1c. Whole 1aa worked out he needs to save $500 (USD) for the year 1c. Whole 1aa enters $5,000 (USD) 1d value. The interest 1c or discount 1c shows as $500 (USD) 1c and the required advance 1b is $4,500 (USD). Whole pays that $4,500 1b with the credit card in the transaction account 1a6 as a POS system. The funds 1b go through to the store 1e as the receiver 1f and then to the bank 1a10 with its processing system 1a8 and data store 1a9. Whole has not decided on what things to buy with the credit on account of the advance 1b+interest 1c that he plans to settle on 1h in 12 months or more. Whole 1aa can decide on what to buy then. However, the Before Pay 1a1 system makes it clear that term in not mandatory as it is an annual interest rate 1c. So that if the customer 1aa wants to spend credit any time before the term of 12 months ends or after the 12 months then the customer 1aa can spend all of the credit any time they want. In alternative embodiments there are set terms for interest for example interest for a maximum of 6 months or a maximum of 12 months. Or a minimum term of 3 months or a minimum term of 3-12 months where the credit cannot be spent. Or any other time frames or terms and conditions can be used. So this is a rolling credit system 1a6 of Before Pay 1a1. When the time or times of spending comes then Whole 1aa can buy any of the products or services 1d that Sainsbury's has available which can include 1d spaghetti, butter, onions, car insurance, Apple gift cards, and so on. The beauty is that the customer is really looking forward to buy their shopping with a way of earning extra funds to buy with 1c which is more than traditional bank interest would be. And Sainsbury's 1e has greater cash flow to operate its business 1e not because they need to money but because it provides for more generating profit 1g in supplying the products 1d from a profitable position 1g when they are chosen as the settlement 1h at any time by Whole 1aa. While Whole 1aa is making 10% on his investment 1b preferably the store 1e would be making a higher percentage than that for example a profit margin of 11%-50% of the on sell price on the sale of their goods and or services. This includes taking into account the same time frame so that overall Sainsbury's 1e is making more money or profit from selling good and services 1d than the what they pay out as interest 1c on an advance 1b by Whole 1aa. Alternatively the store 1e would mark up their products by 15%-120% or to whatever suitable level 1g that the customers 1aa and the store 1e are all making suitable profit 1g and are all happy. This means the system and method 1a1 is profitable 1g to the store 1e and the customer 1aa. A colourful relationship of working together between the customer 1aa and the store 1e is opened up to reveal this welcoming and advantageous system and method 30 to all people involved.

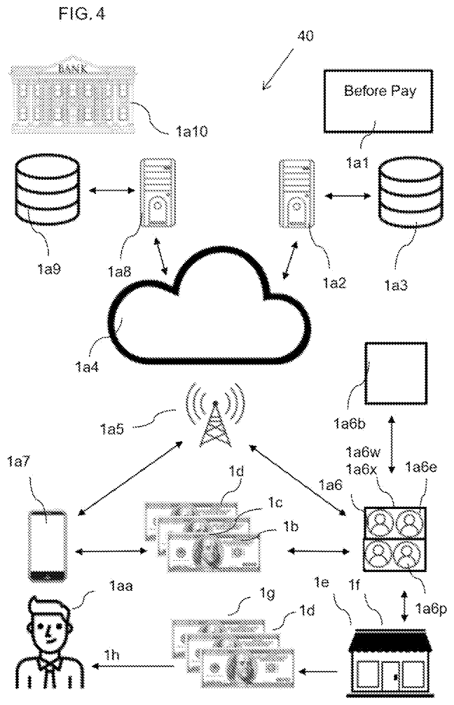

FIG. 4 shows a system and method 40 of a bank or a financing system 40. This system and method 40 includes a bank 1a6b represented by a bank web site 1a6w that includes an exchange 1a6x made up of individual customers 1aa who each have a transaction account 1a6 or POS account 1a6. The parties making up the exchange 1a6x include the people seeking funds 1a6e including entrepreneurs 1a6e and payers 1a6p. A payment or investment or advance 1b is made by a customer 1aa who is a payer 1a6p via their transaction account 1a6 on the bank exchange 1a6x web site 1a6w to an entrepreneur 1a6e or business 1e that is the receiver of the funds 1f who use the funds 1b to generate profit 1g from their business 1e. In an alternative embodiment the bank itself 1a6b does pay or advance or invest the funds 1b to the entrepreneur 1a6e or business 1e. This provides for a return to the customer 1aa of the advance 1b with interest 1c over time to create a settlement 1h. The Before Pay banking system and method 40 includes a Before Pay 1a1 processing system of one or more processors including a server 1a2 with a data store 1a3. The Before Pay system 1a1 is connected to the network of the internet 1a4. The Before Pay 1a1 system optionally includes a program or app integrated with the bank web site 1a6w that integrates with the transaction account POS 1a6 of a customer 1aa account where financial transactions take place 1a6 including 1a6e and 1a6p optionally where there is a record of those for the customer 1aa and receiver 1f or 1a6e. In an alternative embodiment the Before Pay 1a1 system includes an app or program integrated in the bank web site 1a6w with or without there being a Before Pay 1a1 separate server 1a2 and data store 1a3. The Before Pay 1a1 program or app can be one provided by Before Pay 1a1 or one as integrated by the bank for their own web site 1a6w that appears generic and includes the Before Pay system and method 1a1 including fundamental formula V=A+I or V−I=A. The customer 1aa account is set up by providing a unique ID such as a mobile number and or email address, as well as a password, which are also used to log into the transaction account 1a6. The accounts 1a6 including 1a6e and 1a6p include for allowing transactions on the basis of V=A+I that is Value=Advance+Interest or Value−Interest=Advance. On the web site 1a6w there is the ability for each customer 1aa including each entrepreneur 1a6e or each business 1a6e and payer 1a6p to present a profile or present content to allow a customer 1aa payer 1a6p to match or connect with an entrepreneur 1a6e or business 1a6e. The profile may be private or public. If private the matching system can be coordinated by the bank system. The customer 1aa payer 1a6p with their mobile 1a7 or smart phone, or laptop, or desktop, or any other suitable computing device 1a7 goes online via Wi-Fi 1a5 connected to the internet network 1a4 that is connected to the bank web site 1a6w and logs into their transaction account 1a6. The customer 1aa payer 1a6p does a key word search on the bank web site 1a6w and locates several matches to their keywords making them potential investment candidates 1a6e. Any other system or method can be used for a customer 1aa to find a suitable entrepreneur 1a6e or business 1e to invest in. Or for any suitable entrepreneur 1a6e or business 1e to reach out to an investor 1aa to seek investment 1b. As an example, the customer 1aa sees in their account 1a6 section that the Before Pay 1a1 system is Advance+10% per year compound interest=Value. In other examples there can be any suitable interest used, and for any suitable term. Where for example (V) $1,100 1d=−(I) $100 1c=(A) $1,000 1b. The customer 1aa accepts that and chooses an entrepreneur 1a6e to invest in. So for example the customer 1aa pays $1,000 1b to the entrepreneur 1a6e who is the receiver 1f of the funds and the founder of the business 1e. The bank web site 1a6w takes a transaction fee. That can be on the advance 1b or on the settlement 1h or any other method. Any suitable transaction percentage or fee can be used by the bank 1a6b represented by the web site1a6w. The business 1e uses the investment 1b to operate with the intention to make a profit. If the business needs more investment 1b to get into profit then then original customer 1aa investment of $1,000 1b gets rolled over at the rate of 10% compound interest per year. There are no contracts between any of the parties including the bank. There is no paperwork. Any money repaid 1d is done so purely on trust. There can be no legal claim on anybody because there are no contracts in place. The spirit of the system and method 40 is for the entrepreneur 1a6e to be fully supported to make a profit and only to pay a percentage of their profit to pay off an advances 1b. So for example, the bank 40 recommends that any part settlements 1h or complete settlements 1h come out of no more than 10% of the profit made by the business 1e. Preferably this profit means profit after any applicable tax or taxes. Also connected to the internet network 1a4 is a financial service provider processing device 1a8 with a data store 1a9 being part of a bank 1a10 that can receive funds for the store 1e. With the current example, the customer 1aa payer 1a6p after 1 year has a credit of $1,000 advance 1b and $100 interest 1c being $1,100 total value 1d. In 2 years that is $1,100 as 1d+10% 1c as $110 as 1c=$1,210 as 1d. In 3 years that is $1,210 as 1d+10% 1c as $121 as 1c=$1,331 as 1d. When the business 1e makes a profit after tax of over $13,331 then 10% of that being $1,331 as the generated profit 1g is ready to be paid to the customer 1aa and settle the original transaction 1b. In this way the customer 1aa gets the great advantage of having a good return 1g on their investment 1b. Also where the customers is paying ahead and feeling calm and in control of their finances. Also the business 1e has the great advantage of having a committed loyal customer 1aa and of getting increased cash flow to use on their business 1e to generate 1g the products and or services for their business 1e from a profitable position 1g. As a result this system and method 1a1 promotes wealth and can help an entrepreneur 1a6e in poverty to come out of poverty by this process and wonderful experience of abundance and cooperation between the customer 1aa payer 1a6p and the business 1e and the entrepreneur 1a6e as facilitated by the bank 1a6b system and method 40.

FIG. 4 system and method 40 will be further described by way of example. Before Pay Plus 40 is the system and method of a bank that is a registered business 1a6b with the domain www.beforepayplus.com web site 1a6w. The web site 1a6w has a meeting platform or exchange 1a6x. An entrepreneur 1a6e by the name of Seas See 1aa uses their smart phone 1a7 connected by Wi-Fi 1a5 to the internet 1a4 to connect to the Before Pay web site. Seas 1aa sets up a transaction account 1a6 with their email address as the username and with a password. Seas 1aa sets up a profile 1a6 with their basic details of:

Name: Seas See; City: Leeds; Country: England; Business: T-shirt design; Money sought: $6,000; Work done: Domain name registered: www.seetheseas.com; Number of past loans had: 1 ($4,000); Number of past loans repaid: 1.

The content becomes part of an exchange 1a6x that is not public. Note in other embodiments that may be public 1a6x.

An investor 1a6p by the name of Fin Nance 1aa uses their smart phone 1a7 connected by Wi-Fi 1a5 to the internet 1a4 to connect to the Before Pay web site. Fin 1aa sets up a transaction account 1a6 with their email address as the username and with a password. Fin 1aa sets up a profile 1a6 with their basic details of:

Name: Fin Nance; City: Helsinki; Country: Finland; Business: Investing; Money to invest: $5,000-$10,000; Number of past investments: 4; Number of past investments settled: 2.

The web site 1a6w has a key word search system 1a6w. The Before Pay system 1a1 includes one or more processors 1a2 and a data store 1a2 that are connected to the internet 1a4 and connected to the Before Pay web site 1a6w. In other embodiments the Before Pay system 1a1 is integrated into the web site 1a6w and does not need a separate system 1a2 and or 1a3. The key word search system is conducted by staff of the Before Pay bank 1a6b to respect privacy of people's details relating to their account 1a6. Fin 1aa is matched with Seas for the investment of $6,000. In the transaction account 1a6 the terms of Before Pay are very clear: Rights and obligations: there are no contracts between the parties about investment or repayment and as such there can be no legal claims between the parties at any stage. Any repayments are made on trust and trust alone.

The intention of repayment: out of a maximum of 10% of profit after applicable tax of the entrepreneur's business.

Interest: 10% compound interest per annum.

Fin 1aa decides to invest with Seas 1aa via Fin's transaction account 1a6 and transfers the $6,000 1b. The plan is that will earn 10% compound interest 1c per year. Seas 1aa is the receiver 1f of the advance 1b. The advance lands in Seas bank 1a10 that has a system with one or more processors 1a8 and a data store 1a9 that are connected to the internet 1a4. In the first year Seas 1aa does not make a profit 1g. Nor in year two. In year 3 Seas makes $2,500 profit after tax 1g so pays 10% of that, being $250 to Fin as part settlement 1h. In year 4 Seas makes $22,000 profit after tax 1g so pays 10% which is $2,200 to Fin as part settlement 1h. In year 5 Seas 1aa makes $72,000 profit after tax so 10% means up to $7,200 payment to Fin 1aa. On final settlement 1h the Before Pay bank 1a6b has a 3% transaction fee based on the loan amount 1b $6,000 which comes out at $180. On the final settlement 1h Seas paid $6,062 to Fin and the $180 transaction fee to Before Pay 1a6b being a final payment of $6,242 1h.

The investment value 1d for Fin looks like this:

$$Year 1 : \$6 , 000 ;$$

$$Year 2 : \$6 , 000 + 10 \% that is \$600 = \$6 , 600 ;$$

$$Year 3 : \$6 , 600 + 10 \% that is \$660 = \$7 , 260 - \$250 paid = \$7 , 010 ;$$

$$Year 4 : \$7 , 010 + 10 \% that is \$701 = \$7 , 711 - \$2 , 200 = \$5 , 511 ;$$

$$Year 5 : \$5 , 511 + 10 \% that is \$551 = \$6 , 062 - \$6 , 062 = \$0 .$$

At the time of receiving the investment 1b for her business 1e Seas 1aa was considered on low income with less than $15,000 (USD) per year. By 5 years on in her business 1e with the support of the advance and the goodwill of the encouraging repayment terms 1h Seas was able to earn her way into financial independence including being on over $60,000 (USD) wages per year. All parties to this system and method 40 profit and gain 1g. As there is no pressure to repay any money 1h Seas 1aa was able to flourish and share in a very positive outcome with the help of Fin 1aa and Before Pay 1a6b. This demonstrates a nurturing and vibrant relationship of working together between the customers 1aa in helping a new business 1e get off the ground 1g and add value to the world with a great product 1d, with encouraging energy to the community and the world 1g. These advantages help all people involved by sharing is positive values 1g and 1d and success 1h where all parties are aligned to share in growth 1g and profit 1g. In this method 40 any possible past poverty is overwritten with wealth. And there is no poverty created or sustained by this method 40.

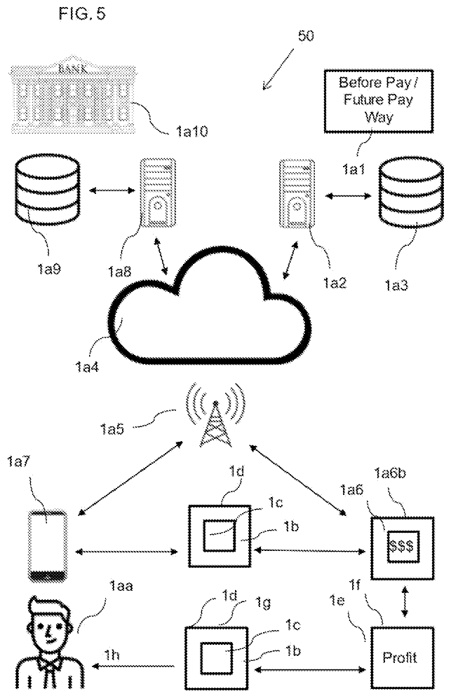

FIG. 5 shows a system and method 50 of the Before Pay system and method 50 that implements the different embodiments described herein. It includes a processing system of one or more processors 1a2 with a data store 1a3. The Before Pay system 1a1 is connected to the network of the internet 1a4. The Before Pay 1a1 system includes a program or app on a supplier 1e POS or transaction account 1a6. In alternative embodiment the Before Pay 1a1 app or program is integrated with the supplier 1e and there may or may not be a separate sever 1a2 and data store 1a3 for the Before Pay 1a1 system. The prime formula for the Before Pay 1a1 system is value (V)=advance (A)+interest (I) that is V=A+I. The interest part can be a lump sum or be calculated with an interest rate for example 1%-5% simple interest, or compound interest, per month. Or an interest amount per year. The customer 1aa with their mobile 1a7 or smart phone, or laptop, or desktop, or any other suitable computing device 1a7 goes online via Wi-Fi or any other connection 1a5 connected to the internet network 1a4 that is connected to the supplier 1e. The customer 1aa chooses to pay via credit card via their account 1a6 for a product or service or investment for a value 1d that includes having the interest portion deducted 1c so that the advance made is 1b that is V−I=A. That is V (value) 1d−I (interest) 1c=A (advance) 1b. The advance 1b is made with a term in mind that can be fixed or that can be ongoing creating the value 1d. Based on that the customer 1aa makes the advance 1b to the transaction account 1a6 that goes to the supplier 1e who is the receiver of the funds 1f. The account 1a6 can include a running balance of credit over time 1d taking into account the interest 1c and advance 1b. Or the account 1a6 balance can be on fixed or agreed on terms. The supplier 1e includes a business 1e that uses the advance 1b to improve or run their business 1e and generate profit 1g in the form of a final value 1d that can be in the form of goods or services or money or in the form of anything else to the value 1d of the product 1d where V=A+I. The value 1d is settled 1h by providing that value 1d to the customer 1aa. The settlement 1h can be final or in part if the settlement includes instalments to bring to a later final resolution 1h. The supplier 1e makes a profit after taking into account the advance 1b and interest 1c and their operating business 1e. This can include because the profit margin they make in their business 1e is higher than the profit margin 1c the supplier 1e pays to the customer 1aa for the advance 1b. Also connected to the internet network 1a4 is a financial service provider processing device 1a8 with a data store 1a9 being part of a bank 1a10 that can receive funds for the supplier 1e. In this way the customers 1aa makes an investment with the advance 1b and in doing so pays a lower amount for the item value 1d they would like to receive 1h. So the customer 1aa is very supportive of the supplier 1e. And the supplier 1e is very supportive of the customer 1aa by rewarding them with the settlement 1h that includes interest 1c that can include a healthy interest beyond the level of a traditional bank. This cooperation by the customer 1aa and the supplier 1e by this energizing and positive system and method 50 adds value to each other and the community at large by fostering trust and openness and sharing, where the sharing includes profit sharing 1d and the settlement 1h.

FIG. 5 system and method 50 will be further described by way of example. A customer 1aa Spend Rite wants to make an investment 1b using Before Pay 50 to earn interest 1c. Spend 1aa uses his laptop 1a7 connected by cable 1a5 to the internet 1a4 that connects to the Before Pay bank business 1a6b represented by a web site that Spend 1aa has a transaction account 1a6 with. Spend 1aa set up that account by providing a username and password. Spend 1aa sees on his account 1a6 that Before Pay 1a1 offers 8% simple interest per year. Spend wants the value of $10,000 1d in 24 months that can be in money or in goods or services-which one he has not decided on at the time of making the advance. The Before Pay systems check formula is V−I=A or Value (V) 1d−Interest (I) 1c=Advance (A) 1b. With the interest of 8% on $10,000=$800 1c in x1 year so for x2 years=$1,600 1c. The web site shows input area for goal amount 1d. Spend inputs the goal of $10,000 1d and inputs the term as 24 months. Output is shown as interest $10,000 value 1d=$1,600 interest 1c=advance $8,400 1b. Also there is a 3% transaction fee for the Before Pay system which is $252 so the total payment by Spend 1aa is $8,400 1b and $252 1b=$8,652. Based on that Spend 1aa transfer the advance 1b to Before Pay via his account 1a6. The advance 1b is used by the Before Pay bank on investing in one or more business 1e it chooses. In two years' time Spend 1aa chooses to redeem the investment 1b in money 1d. In this case the Before Pay bank that invested the advance 1b and or other advances 1b from other investments 1b has received return on returns or settlements 1d and with that pays Spend his return $10,000 as 1d as the settlement 1h. In an alternative embodiment Spend 1aa chooses where to invest the advance 1b with a business 1e and either receives the goods or services 1d or money 1d as settlement at a later time 1h. In this way the customers 1aa makes an investment with the advance 1b into a system and method where people and business operate in profit at all times. Where the customer 1aa is very supportive of the business 1e or supplier. And the supplier 1e is very supportive of the customer 1aa by providing the settlement 1h that includes interest 1c at good interest rates but where no one is pressured to pay those amounts. All parties to the system and method are in alignment so there is no room for error or dispute. And when there is profit it is shared. This creates an atmosphere of people thriving in growth with honesty and hope.

FIG. 5 system and method 50 will be further described by way of example. 50 is the Future Pay Way system also known as the Before Pay system. That is a method of community sustainability. This includes funding a business 1e in advance 1b by a customer 1aa via a bank 1a6b and in return the parties sharing in the profit. This happens by the customer 1aa paying in advance 1b for goods and or services or money 1d, where interest 1c is earned on the advance by the economic formula

$$a + i = v$$

that is (a) advance+(i) interest=(v) value. The value 1d or end product is provided to the customer from profit sharing between all the parties involved in the system 50. The parties include the customer 1aa, the Amazon bank 1a6b, and the business 1e. For example a customer 1aa In Vest wants to sustainably use his money 1b and so put his money 1b in the best place to both help the community and to earn interest 1c as an investment 1b and buy groceries 1d and get taxis when needed 1d in the future. So this is pay now get later type thing 50 for the greater good. In Vest 1aa has an account with the Amazon bank 1a6b or otherwise just known as Amazon 1e that now has Future Pay Way 1a1. Amazon bank 1a6b has partners across many areas of business including banks, markets, supermarkets, medical, insurance, clothing, luxury brands, taxis, travel, hotels, and so on. This allows the customer 1aa to spend their account money there 1a6. This Future Pay Way system 50 system works by the customer 1aa providing cash 1b to their account 1a6 with Amazon 1e which the same as the Amazon bank 1a6b. Amazon 1e pays 7.5% compound interest on the advance 1b to the customer 1aa. Amazon 1e uses that money 1b to invest in businesses 1e it chooses or to loan to a business 1e or businesses 1e where Amazon 1e does earn interest 1c at the rate of 15% compound interest from profit sharing 50. All the while this method of paying in advance 1b helps the business 1e with increased cash flow, where the business 1e only provides return payment 1h or settlement 1h from profit, or the equivalent of profit. The loan 1b by Amazon 1e is paid off by the business 1e at the rate of 10% of revenue of the business 1e each month. That is estimated to what could be considered as about 20%-30% profit after tax. Paying the 10% of revenue is a concrete way of determining what to pay and when so people are not in the dark or so figures don't get misinterpreted when profit after tax can't be calculated as tax returns may not be done in time and there may be some expense areas that are too variable to easily work with. Also working on 10% revenue means Amazon 1a6b can easily see the business 1e account showing receipts of revenue as deposits in the business 1e account. In other embodiments any suitable figures or systems could be used. Many thousands of customers 1aa make these investments 1b to Amazon 1e at the same time around the world. And in turn Amazon 1e makes many thousands of investments 1b in businesses 1e at the same time around the world.

In Vest 1aa uses his laptop 1a7 connected by Wi-Fi 1a5 to the internet 1a4 that connects to the Amazon bank 1a6b using the Future Pay Way system 1a1 via the web site www.amazon.com online 1a4. In Vest 1aa has a transaction account 1a6 with the Amazon bank 1a6b. In 1aa set up that account 1a6 by providing a username and password. In 1aa sees on his account 1a6 that Future Pay Way 1a1 provides 7.5% compound interest per year. In 1aa wants to credit $5,000 USD at that rate to Amazon 1a6b who he trusts will make the returns 1h on that investment 1b while the money 1b is being used for the greater good 50 helping the community that includes profit sharing. That is where the aim is for people to share the profit in amounts even or about even to their input so it is a fair system. So In 1aa does transfer that amount $5,000 USD 1b from his bank 1a10 that is linked to his Amazon 1a6b account 1a6 at the Amazon bank 1a6b. Amazon 1a6b does receive this payment 1a6 along with thousands of other investors 1aa around the world via their transaction accounts 1a6. In this way Amazon 1a6b is a bank with a large pool of funds 1b to invest. Of course Amazon 1a6b is careful to make sure that if all the customers 1aa want to withdraw their account funds at the same time that all those funds are available and are not all invested or loaned out 1b. So Amazon 1a6b is always trading in profit. The philosophy of Amazon 1a6b with the Future Pay Way system 50 is to invest 1b or provide advances 1b to entrepreneurs or businesses 1e as the receivers 1e of funds in order to help their business 1e and to make money by profit sharing between the customer 1aa, Amazon 1a6b and the businesses 1e. And in doing so this system 50 is sustainable. Also where no party along the way has to pay out money when they are not really in a position to do that. So poverty cannot be created from this system 50. Wealth is created from this system 50. Such that no person can experience any poverty with this system 50 as money is only paid out from a cash positive position 1e. The terms of Amazon 1a6b loaning out the funds 1b is that repayments will be 10% of any revenue of the business 1e account. Amazon 1a6b has a running client base on the data store 1a3 for the Future Pay Way system 1a1 of businesses 1e applying for loans, ranging from mini $50 to metro $100k and more. Amazon 1a6b chooses one who is after $5,000 and Amazon 1a6b does invest that to the business 1e called Three Trees 1e who is the receiver 1f of the $5,000 advance 1b. Three Trees 1e is owned by an entrepreneur 1e who can be considered in poverty who has an income of less then $10,000 USD per year. Three Tree 1e has a new way of making baked broccoli snacks to start selling as a street vendor in NYC 1e.

The figures looked like this:

Advance 1b from the customer 1aa to Amazon 1a6b of $5,000 USD.

Advance 1b from Amazon 1a6b to the business 1e of $5,000 USD.

### 10% of Revenue as Repayments

$$Business 1 e year 1 : revenue \$5 , 000 profit repayment 10 \% = \$500$$

$$Business 1 e year 2 : revenue \$7 , 500 profit repayment 10 \% = \$750$$

$$Business 1 e year 3 : revenue \$10 , 000 profit repayment 10 \% = \$1 , 000$$

$$Business 1 e year 4 : revenue \$15 , 000 profit repayment 10 \% = \$1 , 500$$

$$Business 1 e year 5 : revenue \$25 , 000 profit repayment 10 \% = \$2 , 500$$

$$Business 1 e year 6 : revenue \$50 , 000 profit repayment 10 \% = \$5 , 0.$$

### Business 1e Amazon Running Balance

$$Balance year 1 : \$5 , 000 + interest \$750 = \$5 , 750 - \$500 = \$5 , 250$$

$$Balance year 2 : \$5 , 250 + interest \$787 \text{.50} = \$6 , 37.5 - \$750 \text{} = \$5 , 287.5$$

$$Balance year 3 : \$5 , 287.5 + interest \$793 \text{.13} = \$6 , 80.63 - \$1 , 000 = \$5 , 80.63$$

$$Balance year 4 : \$5 , 80.63 + interest \$762 \text{.09} = \$5 , 842.72 - \$1 , 500 = \$4 , 342.72$$

$$Balance year 5 : \$4 , 342.72 + interet \$651 \text{.41} = \$4 , 994.13 - \$2 , 500 = \$2 , 494.13$$

$$Balance year 6 : \$2 , 494.13 + interest \$374 \text{.12} = \$2 , 868.25 - \$2 , 868.25 = \$0 .$$

Total interest paid $4,118.25.

### Customer 1aa Investment 1b Running Balance

$$Customer 1 aa year 1 : \$5 , 000 + interest 7.5 \% as \$375 = \$5 , 375$$

$$Customer 1 aa year 2 : \$5 , 375 + interest 7.5 \% as \$403 \text{.13} = \$5 , 778.13$$

$$Customer 1 aa year 3 : \$5 , 778.13 + interest 7.5 \% as \$433 \text{.36} = \$6 , 211.48$$

$$Customer 1 aa year 4 : += \text{} \$6 , 211.48 + interest 7.5 \% as \$465 \text{.86} = \$6 , 677.35 \text{}$$

$$Customer 1 aa year 5 : \$6 , 677.35 + interest 7.5 \% as \$500 \text{.80} = \$7 , 178.15$$

$$Customer 1 aa year 6 : \$7 , 718.15 + interest 7.5 \% as \$538 \text{.36} = \$7 , 716.51$$

Total interest paid $2,716.15 and prime $5,000 and total $7,716.15.

### Based on the Economic Foundation

$$a + i = v$$

$$a ( \$5 , 000 ) + i ( \$4 , 118.25 ) = v ( \$9 , 118.25 )$$

Taking into Account the Above it can be Seen Also Based on the Economic Foundation

$$v - i = a$$

Where the customer 1aa gets a settlement 1h of $7,716.51 with $2,716.51 being interest 1c.

Where Amazon 1a6b gets a return 1h of $1,401.74 as the interest 1c.

By year 7 the business 1e makes $100,000 revenue with $40k as wages to the owner. The owner can now be considered out of poverty as helped by Amazon 1e and the customer 1aa In Vest.

In other embodiments the customer 1aa and Amazon 1a6b share the profit 1c 50/50 or any other suitable amounts.

In other embodiments the customer 1aa and Amazon 1a6b and the business 1e share the profit 1c ⅓:⅓:⅓ or any other suitable amounts.

In other embodiments the investor 1aa can designate which business 1e or businesses 1e they will invest in with their advance 1b.

In other embodiments any other suitable interest can be used. For example the results could otherwise come out over 10 years as

$$a ( \$5 , 000 ) + i ( \$10 , 000 ) = v ( \$15 , 000 )$$

In this example above of v=$15,000 the customer 1aa and Amazon 1a6b share the profit 1c as 50/50 so they get $5,000 profit 1c each. The customer 1aa gets return of the advance 1b $5,000 plus the profit $5,000 which is a total return 1h of $10,000 of value 1d.

In another example of the above where v=$15,000 the customer 1aa and Amazon 1a6b and the business 1e share the profit 1c as ⅓:⅓:⅓ so they get $3,333.33 profit 1c each. The customer 1aa gets return of the advance 1b $5,000 plus the profit $3,333.33 which is a total return 1h of $8,333.33 of value 1d.

In the original example in this description the customer 1aa has invested $5,000 at 7.5% interest 1c with Amazon 1a6b who gets 15% interest. So it is equal at 7.5% each as in 7.5%:15%. As it turned out the time frame that the business 1e settled 1h the investment 1b was 6 years. After that from his credit balance of $7,716.51 1h the customer 1aa used $4,500 over a period of time of 6 months on groceries 1d at a supermarket that is a partner with Amazon 1a6b. The 6 month period earned around a further $168.75 in interest 1c. The customer 1aa also used $500 on taxis 1d that are also a partner with Amazon bank 1a6b. Being a partner with the Amazon bank 1a6b means the partners will accept payment from the Amazon bank 1a6b banking system or via their app. Also where the cash flows stays in the Amazon bank 1a6b system so its net balance does not go down with a withdrawal or payment by customers 1aa or businesses 1e to another customer 1aa or business 1e. This left a balance of $2,885.26 on the credit made up of interest 1c left on the customer 1aa account 1a6 to either withdraw out or continue to use with the Amazon bank 1a6b and its partners. The Amazon bank 1a6b or Amazon 1e has partners or affiliates that are many millions of merchants and suppliers around the world. To further demonstrate these partners includes businesses 1e and organizations of all sorts, including for example banks, universities, shopping malls, cafes, hotels, supermarkets, airlines, insurance companies, clothing brands, luxury brands and any other suitable type of business or company. So the Amazon bank 1a6b is a new sustainable banking system that puts all parties in alignment, the customer 1aa, the bank 1a6b, and the business 1e. And where the input energy of each is reflected by the output to each. Or at least along those lines as that is the spirit of it. This helps businesses by paying in advance to them, improving their cash flow, and where they provide output from a profitable position. This includes where the customer 1aa is rewarded with interest. Just as the bank is too 1a6b. Likewise all parties benefit from profit sharing between the customer 1aa, Amazon 1a6b, and businesses 1e so they are all on the same page and have their interests aligned. This also means all parties who invest share in the profit in a fair way by returns that preferably fairly reflect their investment 50. There is great power in paying in advance because providing cash flow without asking for exchange of value or goods at that time does free up the receiver of the advance payment. It is this freeing up that is the foundation of starting Future Pay Way, the act of giving without asking in return to start. And the trust that there will be giving in return but only when they are free to do s 50. That means the energy input, which can include money and when that is paid, and anything else relevant, of each is reflected in the output of profit returns. If not exactly it would be along those lines as that is the feeling of it, that is the spirit of it, the spirit of Future Pay Way 50. This creates harmony and sustainability 50 for all parties, in the community and the world around us. This shows great moral support, financial support, and demonstrates hope and trust for the future of all. In this system 50 there is no poverty created because money only changes hands from a profitable position.

In this way Amazon 1a6b completely supports the business 1e and does not make any pressure to make repayments on the advance 1b for money the business 1e does not have or does not realistically have based on a real complete stock take analysis. So the business 1e makes repayments conditional on revenue being first received by the business 1e where that revenue should be or is equivalent to a portion of profit. This cooperation between the investor 1aa and Amazon 1a6b and the business 1e means they are all in alignment and want the business 1e to become profitable before money is to be repaid 1d to Amazon 1a6b or the investor 1aa. This gives the best chance of success to the business 1e and demonstrates great belief and positivity by the investor 1aa and Amazon. Overall this creates an atmosphere of trust, encouragement, hope, enlightenment, and succuss. Team work. When one succeeds they all succeed. This is the Future Pay Way of banking. This is the Future Pay Way. In this way people in the world are support to feel good energetically by this invention and are helped materially to feel good at the same time.

It is noted that in FIGS. 1-5 the items 1a1 through to 1a10 correspond to or form part of item 1a in FIG. 6.

FIG. 6 shows a schematic diagram of an aspect of the invention being a computer implemented method 60. 1a shows one or more processors. 1b shows payment being made from a payer. 1c shows the step of interest being charged or earned on the payment amount. 1d shows the value which is the buy price being the payment amount and interest total. 1e shows a web site or shop or supplier where the transaction process takes place. 1f shows the receiver such as a shop as a receiver of the payment 1b. 1g shows the step of the supplier 1e generating 1g a product or value 1d. 1h shows the step of the supplier 1e settling the payment 1b with interest 1c to create the value or the buy price 1d that matches the settle price 1h.

This method 60 will be further described by way of example. A customer called Sole walks into a shoe shop called “Soul Shoes”. Sole tries on three different shoes. He finds the one. That he likes. They are Heartland Style. They retail for $295.63. At the checkout he has different payment options. Buy now pay later. Credit card. That sort of thing. Then one catches his eye. A new system called Before Pay. The shop assistant explains the system. In summary it works by payment in advance 1b that together with interest 1c at the rate of 30% per year over 3 months means Sole pays now $275. At the rate of 2.5% interest per month means $6.88 in interest per month 1c. Over 3 months this means $20.63 1c. With the advance payment of $275 1b this totals $295.63. Happy with that Sole decides to go ahead with Before Pay. It worked like this. At the point of sale pay terminal 1a of the store 1e the assistant rings up the sale of goods that is x1 Heartland Style $296.63. Before Pay. In the process she gets Sole's mobile number and email for the transaction 1e. Sole gets a text from the shop to click on the link for Before Pay 1a in order to create an account (if he doesn't have one already) with Before Pay 1e which is simply to see and manage the progress of any payments or transactions he has on Before Pay. The shop processes the $275 advance payment 1b to the shop 1e receiver 1f. Sole gets a text and email confirming that and saying he can pick up his shoes in 3 months. 3 months later Sole returns and picks up his likable Heartlands 1g, for the settle price of $293.63 from the shop 1e. So in this way Sole is happy as he saved $20.63 which is more than he would have made by bank interest. Also the shop is happy as they used the $275 advance payment 1b to order and bring in the product 1g to order and settle 1h the advance payment 1b later. The shop made $20.63 less 1c from Sole from the asking price of $293.63 but still made 100% mark up on the goods which is $137.50 and also got their profit margin up front at the time of the advance 1b improving the business 1e cash flow. At the time of the advance payment of $275 there is an additional transaction fee of 1% for the business Before Pay which is a total of $2.75. In this way the shop is operating with no excess stock, is sustainable, is providing product 1g from a cash positive or profitable position. Also in this way the shop 1e is not able to experience any poverty from this type of transaction as the shop 1e only provides goods 1g from a free or profitable position 1h. Further the shop 1e did not have to discount the goods 1g and so hold the good value 1d and 1h and yet the customer experiences either what would be a discount or attractive earnings 1c on their valuable asset of advance payment 1b. All in all the customer 1b and the shop 1e and 1f really cooperate well in this organic and complementary system.

A further description of FIG. 60 will be shown by way of example. In this example there is the chain of stores 1e and online store 1e for Louis Vuitton. A customer 1b called Dee Sign goes online and selects a bag to purchase. It costs $12,000 with Before Pay 1b. This is based on paying the $12,000 six months in advance before receiving the chosen bag. This includes interest 1c of 5% per month which is $600 per month for 6 months means total interest 1c of $3,600. The buy price 1d of the bag to receive the goods on payment is $15,600 as seen at 1h. So Dee Sign buys the bag on 1 Jul. 2024 1b for $12,000. At the time of purchase Dee Sign has options as to what form of payment system she wants. This includes Credit Card, After Pay and Before Pay. Dee selects Before Pay enters her name, email, mobile, and gets an email and text with link to Before Pay to either log in to her account or set up account to manage and view the status of transactions 1a and 1e. The receiver 1f Louis Vuitton obtains the advance payment 1b and uses those funds to produce or bring in the bag 1g which it supplies to customer 1b on settlement 1h on 1 Jan. 2025, or any time after that the customer want to pick up their bag 1g. Alternatively the customer can get the bag shipped to them as part of the settlement 1h by any suitable means such as a courier that can include DHL or FedEx. In this way the customer enjoys a saving of $3,600 on the buy price 1d and 1h and yet the seller 1f did not apply a discount which could otherwise imply a perceived problem with the product. For example, if the bag was otherwise discounted a customer might ask, is there something wrong with the bag that it is not the full price? With this example the shop 1e only provides the product 1g from a profitable position and is at no time under financial risk from this method 60. As part of the trade off to not carry any risk, the supplier 1e receives less cash of the payment 1b however as it is in advance, when the interest value of that makes the transaction very pleasing to both the shop 1e and the customer 1b. The shop made $3,600 less 1c from Dee from the value price of $15,600 1d at the time of the advance 1b but still made 100% mark up on the goods which is $6,000 and also got their profit margin up front at the time of the advance 1b improving the business 1e cash flow. For the transaction of the $12,000 there is an additional fee being a transaction fee of 3% to the organization Before Pay which equates to $360. This method 60 demonstrates how the customer with their payment 1b cooperates well with the shop or supplier 1e creating a balanced and computer implemented sustainable system and method.

The method 60 will be further described by way of example. 1e shows the Before Pay web site of beforepay.com and also the web site of each shop 1e or store 1e selling products that have the payment facility 60 of Before Pay. When customers use Before Pay 60 for example the first time making a purchase 1b in a store 1e they provide their name, mobile, and email address as part of setting up their account on the Before Pay 1e web site. The customer gets a text message and their mobile and an email where the customer can click on either of those and be prompted to set up an account with Before Pay 1e. That includes providing a password with either of their unique identifier of their mobile or email address. When the customer does that after being prompted from a purchase 1b they see a dashboard allowing the customer to track, view and manage their purchases 1e. All from the one place on the Before Pay web site 1e. So the supplier or the store 1e selling the product 1d has the Before Pay application set up on their point of sale set up that is online and linked to the Before Pay web site. So when a customer buys a product 1g with the advance payment 1b to be picked up or shipped to them later, for example 3 months later, at the buy price time 1d, the customer can in the meantime see their purchase on the Before Pay web site 1e. This facility 1e of the Before Pay dashboard is convenient for the customers because the system 1e allows the customer to see all their Before Pay 1e purchases from any amount of different stores 1e on the one web site 1e. This stock take and management system of the Before Pay web site 1e is also helpful to the seller as it provides support to the shop and the customers alike by clearly presenting what items were paid for 1g, where, when 1b, and the date they become available to the customer 1d. The supplier 1e or the shop 1e also sets up and has their account with Before Pay 1e also showing them a list of all sales 1b, and their related details. The Before Pay organisation 60 and web site 1e gets paid a transaction fee on each transaction. This can happen at any suitable time and for any suitable amount. For example when the customer makes the advance payment 1b an additional 1% transaction fee is paid to the store 1e selling the product 1g. For example if the advance payment 1b is $300 then at 1% the additional transaction fee is $3. So the total payment to make is $303 1b. Following that, the transaction fee is transferred from the shop 1e to Before Pay 1e. A reconciliation of all transaction fees that are listed on the Before Pay 1e web site 1e are summarized and processed as a payment from the shop or store 1e to Before Pay 1e for example every month. Another way the transaction fee is processed is like this. The customer makes the advance payment 1b together with the 1% transaction fee. The shop or store 1e automatically pays the transaction fee to Before Pay 1e at the time of each transaction to the store or shop 1e. Any other suitable method can be used to get the transfer fee to Before Pay 1e. Also any suitable transaction fee percentage or flat fee can be used.

This method 60 will be further described by way of example. An online store 1e called The Hat Trick sells hats. A customer called Wide Brim goes online 1a to the store 1e and finds the design he wants called Side Brim 1d. The buy price 1d is $100 and the Before Pay price is 25% less which brings it to $75 paying 3 months in advance 1b. Wide goes for that and at the checkout enters in the discount code section the code “BeforePay” which brings the price from $100 1d down to $75 1b which is paid to the store 1e and the receiver 1f which includes the store owner 1f. The Before Pay system and method 10 with advance payment 1b can be seen as a discount 1b on the buy price 1d although it is actually an advance payment 1b with earned interest 1c bringing the value to the buy price 1d. This allows for 3 months of interest 1c which is $8.33 per month or 11% interest per month of the $75 advance payment 1b. During the checkout stage Wide Brim enters his name, email address and mobile number. The store 1e keeps a data log of all purchases made with Before Pay 1e by advance payments 1b with the identification of each client by their email address and mobile. The store 1e emails a receipt to Wide Brim. It's funny you know, realizes Wide Brim, that's the third Before Pay transaction he's made this week. Wide Brim is getting used to this new system 60 as he is spending less and getting ahead of his purchases, where he is looking forward with nice anticipation to receive the things he has bought 1b. Wide Brim has already set up an account with the Before Pay web site 1e using his email address and a password with his mobile 1a as further identification. The store 1e The Hat Trick also has an account with the Before Pay web site 1e. The Hat Trick owner 1f logs onto the Before Pay web store 1e and uploads the log or updates the log of the Before Pay purchases made. The store 1e data is integrated into the Before Pay store 1e web site. This includes the one by Wide Brim. So when Wide Brim logs onto Before Pay 1e web site he can see all his purchase made by Before Pay 1b advance payments. On his dashboard of the Before Pay web site 1e there is a section on offers. This is a marketplace of different stores 1e that Wide Brim has been to and others he has not that offer attractive deals on buying things on stores 1e with Before Pay advance payments 1b. This includes offers from the store The Hat Trick 1e which offer 11% interest per month for at least 3 months on advance payments 1b. For example on $200 advance payment 1b that means $22 per month in interest which over 6 months means $132 1c bringing the total buy price 1d to $332. This system of a marketplace 1e on the Before Pay web site 1e is attractive to the store The Hat Trick 1e and many others as they get a form of advertising and a profile in the marketplace 1e of the Before Pay web site 1e. In an alternative embodiment instead of the store 1e uploading the log of their Before Pay purchases 1e the point of sale set up includes an application or program of Before Pay that automatically provides the relevant data to the Before Pay store 1e in real time or close to that. In a bit after 3 months from the purchase 1b the product 1g is shipped to Wide to settle the transaction 1h for the buy price 1d of $100. There is a 1% transaction fee for Before Pay 1e on the advance amount 1b to be paid to Before Pay 1e which is $0.75 for the Wide Brim purchase of $75 advance payment 1b. This can be done automatically with each transaction if the Before Pay system is integrated into the point of sale system and online to the Before Pay store 1e. This automatic transaction of the additional 1% can be added to the advance so there is the one transaction of $75.75 for the one product the Side Brim or there can be two separate transactions for the Side Brim being one of $75 and one of $0.75. Following this, the amount due of $0.75 gets paid from The Hat Trick store 1e to the Before Pay store 1e. Alternatively, when the store The Hat Trick 1e uploads their log of Before Pay sales 1d and all relevant details such as email address, mobile number, item, cost, date, term of advance, etc to the Before Pay web site 1e reconciles all sales against the email address owners in relation to the specific store 1e to show which ones the store has paid a transaction fee on or not to Before Pay 1e. The transaction fee is of 1% on the advance payment 1b to be paid to Before Pay store 1e. If that is all paid already there is no more to pay. If the total has some outstanding amount that is to be paid on the acceptance of the upload of data from the store 1e. The shop 1e made $25 less 1c from Wide Brim from the value price of $100 1d at the time of the advance 1b but still made more profit than that on the mark up on the goods which is put the store in profit and also where their profit margin was up front at the time of the advance 1b improving the business 1e cash flow.

The method 60 will be further described by way of example. See 1f is the owner of a watch store 1e called Watch Us. A customer called Is That shops online at Watch Us 1e connected by one or more processors using his computer connected to the internet and servers 1a and the store 1e point of sale system as part of the store 1e. Is That already knew Before Pay 1e was at Watch Us because he has an account with Before Pay 1e and saw that listed as an offer for the store 1e. Is That deposits $5,000 into his Before Pay 1e account 1b. This money can be held by Before Pay 1e or by the designated shop 1e he intends to spend the money 1b at. This is for future purchases using Before Pay 1e. Is that pays an advance for The Dial watch for $1,700 being paid 6 months in advance at the rate of 5% interest per month 1c. The interest is $85 per month 1c and over six months is $510 1c bringing the value to $2,210 for The Dial 1d. This leaves $3,300 in his account with Before Pay 1e or the shop 1e attracting the ongoing interest at 2.5% per month 1c which is $82.50 per month 1c. Is That can use his funds at any time later to advance 1b for other purchases 1b. He gets his watch from Watch Us 1e shipped 6 months later 1g and the buy price 1d is settled for $2,210 1h with the watch 1g. To be paid a transaction or service fee to Before Pay 1e from the store 1e the store Watch Us has agreed to pay 3% of its profit after tax. The advance payments 1b from customers are not taxable as they are treated as al loan 1b. So the store Watch Us is more profitable that it would otherwise be from selling goods in the conventional system of supplying goods on payment. The store Watch Us 1e does their tax returns, it gets processed and their figures include:

### With Before Pay 1e

Sales units 5,000, Retail each $2,000 (where the Before Pay price is 75% of the buy price), Revenue $10m, Service Fee $5m, Theoretical Profit After Tax $2.1m, Per Quarter $525k, 3% for Before Pay 1e is $15,750.

In this way the store Watch Us 1e is only paying when they are in profit and there is no risk or poverty in their transactions from this system and method 60 relating to Before Pay 1e. It is noted that if the store Watch Us 1e used the traditional sales system we see the following for comparison:

### Without Before Pay 1e

Sales units 5,000, Retail each $2,000, Revenue $10m, Service Fee $0m, Theoretical Profit After Tax $5.6m, Per Quarter $1.4m, 3% for Before Pay is n/a.

So using this system and method 60 the store Watch Us 1e obtains the service fee for the advance service of $5m providing greater cash flow and operating profit. So the store Watch Us 1e does not own the goods it purchases but rather gets a fee for handling them for the buyer See by the advance 1b. Before Pay 1e is only paid from profit the store Watch Us 1e makes that Before Pay 1e made for it. So Watch Us 1e is never out of pocket.

The method 60 will be further described by way of example. Jenny Shirt has an online clothing store 1e called The Country Way. It is online and works with one or more processors 1a including the internet, servers, and people from around the world being able to log onto it 1a. Jenny 1f offers Before Pay 1e as its sole way of transacting. Sort Out uses the one or more processors 1a via the internet and computer 1a and logs onto The Country Way 1e. Sort buys the combination The Set for $150 that is Sort pays the advance 1b of $150 that is for The Set 1g that retails for $200 1d. The interest component for The Set is $50 1c to be settled in 4 months 1h by delivery of goods then 1h. On payment Sort enters his email and mobile 1b. Sort later gets an email prompting him to set up an account with Before Pay 1e which he does. 4 months later sort gets The Set for $200 1h and 1d delivered to his home. Before Pay 1e is to get a 3% percentage of the profit after tax of The Country Way as the fee for using the Before Pay 1e service. As The country Way 1e is facilitating the sale of the product 1g by the advance 1b the store 1e The country Way does not own the goods 1g and for that gets a service fee for handling the goods and making the delivery 1h of the goods 1g. The figures comes out as:

### With Before Pay 1e

Sales units 4,000, Retail each $200 ($150 with Before Pay), Revenue $600,000 (where the Before Pay price is 75% of the buy price), Service Fee $400,000, Theoretical Profit After Tax $105,000, Per Quarter $26,250, 3% for Before Pay $787.50.

The Service Fee is the amount of the revenue from the Before Pay 1e price less the cost of the goods from the supplier such as the wholesaler or manufacturer. In this sense the Service Fee can be considered a profitable amount. In an alternative embodiment the Before Pay 1e fee can be a percentage of the Service Fee $400,000 which at 3% is $12,000 for the year.

To compare otherwise with traditional sales system would be around:

Sales units 4,000, Retail each $200, Revenue $800,000, Expenses $250,000, Service Fee $0, Theoretical Profit After Tax $385,000, Per Quarter $96,250, 3% for Before Pay is n/a.

The shop 1e made $50 less 1c from Sort from the value price of $200 as 1d at the time of the advance 1b by paying $150 but still made more profit than that on the mark up on the goods which put the store in overall profit from this purchase and also where their profit margin was up front at the time of the advance 1b improving the business 1e cash flow. This method 60 demonstrates that the store 1e The Country Way only operates in profit from the method 60 and only pays Before Pay 1e from profit it makes. The system 60 shows that there can be no poverty from this method and there is no room for poverty to dwell in 60. Further this method 60 creates and supports wealth where the receiver 1f Jenny has a profitable business 1e The Country Way with less risk and more profit, more enjoyment, more cooperating with the customers with Before Pay 1e and where See gets the benefit of getting goods 1g worth more than they paid 1b for while supporting a great business 1e The Country Way and Before Pay 1e.

With reference to FIG. 60 a computer implemented method of a bank will now be described. 1a shows one or more processors. 1b shows an advance payment from a bank reserve or from another party to enable the transaction 1b. 1c shows interest to be applied to the advance payment. 1d shows the value of the transaction being the combined payment 1b and interest 1c. 1e shows the business or shop or store or facility related to the receiver 1f of the advance payment 1d. 1g shows the generation of funds by the receiver 1f or store or supplier 1e. 1h shows the step to settle the transaction by payment of funds 1h to the bank or supplier of the funds 1b. The settlement amount 1h equates to the value 1d. This demonstrates that for the advance payment 1b whether that be a loan or anything else, there is no repayment schedule for return of any money. This is because settlement 1h only happens after generation 1g of funds from operating a business 1e. In this way the receiver 1f only operates from a cash positive position or a profitable position at all times and there is no experience of poverty in this method 60. Also with this method 60 there is no way this can lead to poverty. As a result this is cure to poverty as it can provide for someone in poverty to generate wealth 1g where they only need to pay out to the funder 1b after they freely have the money to do so. Further this instils a feeling from the bank to the borrower or the client warmth trust and moral support to be honest right and fair. This method 60 can be used around the world by people of all different status levels, from rich to poor which demonstrates that having a standard or equalizing system and method is how poverty is erased or in other words and more accurately is simply not part of the picture of this method 60.

This method 60 will now be described further by way of example. A friendly person by the name of High Light lives in poverty. High is eager to get out of poverty and has ideas to start a business using her natural aptitude. She feels working on things she is passionate about is not only easy but rewarding to her and the people around her adding richness to the community. Her business idea 1e is to make shirts and start by selling them to people in her village. For women. For men. Each unique. And after that looking way ahead somehow sell them online 1e. The problem is she has no money 1b to start the business 1e. And she is scared about the pressure to commit to repay 1d a loan 1b when she doesn't know the dates as to when she will get her income and profits, all going well. A friend told her about the bank that does the loans 1b where you pay after you make the profit 1g. Nothing before. High Light checked it out online 1a. It is called Before Pay 1e. She applied for the loan and got an advance payment 1f of $1,000 1b from the bank at 20% interest rate 1c per year. The repayment terms were that there is no repayment schedule. High can pay whatever amount she wants at any time she wants, but at the latest it would be a maximum of 10% of her profit after tax 1d. With the advance 1b High 1f gets the business going called One Off Shirts 1e. In year 1 she generated $800 1g and did not make a profit. In year 2 she made $3,800 and her expenses were $3,000 and so her taxable income was $800. As that was below the tax threshold she had no tax to pay. Based on that generation 1g her repayment to the bank at 10% was $80. In year 3 she made $5,000 after tax from which she paid her 10% being $500 to the bank. This continued each year until the vale 1d was paid off in full being the advance 1b with all applicable interest 1c. In an alternative embodiment the repayment terms are that there is no repayment schedule but instead there would be practice of regular repayments that get paid by High and go into saving for her but with the gravity of needing to make loan repayments. This is to foster the approach of savings with the diligence and convention of loan repayments 1h. The beauty of this method 60 is that the bank makes a solid return 1h on its payment 1b. However the client has no pressure to repay the advance 1d as it is only payable when the customer 1f is cash positive or in profit and freely able to pay 1h that towards the value 1d by the process of settlement 1h. As can be seen by this system and method there is no experience of poverty and there is no poverty. This system and method 60 does not take part in a system that enables poverty. As a result poverty is gradually replaced by wealth first hand as experienced by the receiver 1f. And then to people around them. Further this system and method 60 encourages and shares the spirit of wealth, moral support, hope, savings and sharing. That in itself is a feeling of wealth before the generation of funds occurs 1g.

This method 60 will be further described by way of example. A lady by the name a Give And Take lives in a big city. There is more than 4 million population. A cup of coffee can cost more than US $4 and a Big Mac over US $7. Give lives in poverty. She has a plan to start a business 1e and get out of poverty. Her idea is to run a business in line with her natural skills and thinking. Her passion. Give decides to try and create a business as an artist. A painter. Give logs onto the web site 1a beforepaycapital.com. There she is invited to set up an account and a brief profile about her and her business 1e. Before Pay Capital is a bank. A new type of bank 60. The bank gives out funding for new businesses 1e from its own reserve 1b or from an exchange where a customer from around the world funds the business 1e via the Before Pay Capital web site 1e. To sign up as a funder or applicant for funding the primary goals are to be agreed on. These include the spirit and scope of the bank 1e being to fund people to move out of poverty and into wealth 1e. And help people in wealth continue in wealth 1e. In this case Give settles her profile and she is happy with that. There are 3 key words in her profile aim being: artist, painter, Give. Location: Japan. A funding member 1b by the name of Art Stance from Seattle goes on the Before Pay Capital web site researching profiles to make a new investment 1b. He does a search on the key words “artist” and “painter’ and several results come up. One is Give. Art checks her profile and see she needs US $24,000 to fund her new business as an artist 1b. This is on the basis on projected expenses or around $2,000 a month for 12 months. Give projects that by month 9 she will be ready to sell works online for $3,000 each. The spirit and scope of Before Pay Capital 1e is to help people get out of poverty and also for people out of poverty already to help them thrive further. There is an optional vetting process 1e for the funder to ascertain trust in Give or for the funder and the entrepreneur to build a trusting relationship 1e. This is also helped by the optional vetting process of the Before Pay Capital web site 1e that goes through certain details about the applicant and publishes them as verified on the profile 1e. Such as city location 1e. Business name registered 1e. Trade Mark applied for 1e. Domain name registered 1e. And so on. Things that show genuine merit and diligence 1e. So Art decides to fund Give. He transfers 1b the US $24,000. There is an additional 3% transaction fee 1b that is paid to Before Pay Capital which is $720. Give receives the funds 1f and continues the business 1g. Give had already started the business by buying the domain name giveartworks.com and designing a web site on Shopify 1g. The terms of the finance is 20% per annum compound interest 1c. There is no repayment schedule or plan 1d. The entrepreneur is totally free to focus on their business 1d and 1g. When they achieve profit after tax they are recommended to pay a settle 1h amount each 3 months to bring things up to date which means paying outstanding interest at least but not necessarily settling 1h the whole transaction 1d. Or a settle amount 1h can be paid to settle the entire transaction 1d. As is recommended in order to be fair and helpful to the entrepreneur and not burden them the settle amount 1h comes out of a maximum of 10% of the profit after tax that Give gets from the business 1g. This continues each 3 months until the advance payment 1b and interest 1c creating the value 1d is fully settled 1h. Out of the settle amounts 1h an amount of 97% goes to the funder Art and 3% goes to the bank Before Pay Capital as a service fee. This funding helps Before Pay 1e be able to fund other people and businesses 1e. In year 1 Give made $0 profit after tax so there was no settle amounts 1h to pay. In year 2 Give made $5,000 profit after tax so $500 was paid to settle 1h that amount. In year 3 Give made $20,000 profit after tax so $2,000 was paid to settle 1h that amount. In year 4 her prices went up and she sold more art works and she made $100,000 profit after tax so $10,000 was paid to settle that amount 1h. This continued until the total settle 1h amount was paid that equalled the value 1d amount. As we can see the Before Pay bank 60 provided for a third party Art to advance 1b to Give 1b the funding where Give grew out of poverty doing something she loves. Give went from an annual wage of less than $20,000 (USD) per annum to more than $80,000 (USD) per annum. And where people love her art. Or some people do anyway. And Art made a solid return of 20% interest per annum 1c less fees 1c to Before Pay 1e. And the Before Pay Capital bank 1e and 60 helped this to happen and made revenue along the way to go to its own reserve to then be able to fund other people 1e and projects 1e. In this way Give 1f was able to move out of poverty and at no time had to make any payments when she didn't actually have the money. Or where she was in profit and had the money when she was to make the payments 1h. Give always conducted things from a wealthy position 1f and 1g and 1h of being cash positive and only paying things from a profitable position 1h.

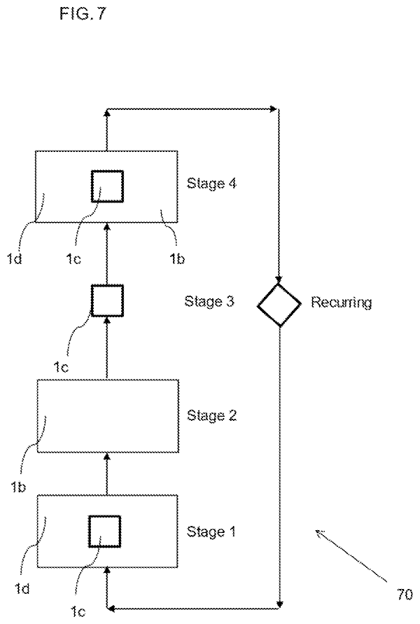

FIG. 7 shows a schematic diagram 70 of a method and a computer implemented method of an aspect of the invention. 70 shows the steps involved in the process or the mechanics of the Before Pay transaction system and method 70. This applies to all examples as shown herein in line with the system

v−i=a

Stage 1 shows 1d the value such a product, service or money. 1c in that shows the potential interest 1c component or the allocated discount or interest component 1c. This Stage 1 is primarily where a customer identifies the specific or exact value of goods or services or money they would like to acquire. This allows being able to calculate how much advance to pay and v−i=a.

Stage 2 shows the advance made 1b

$$v - i$$

$$and$$

$$a = v - i$$

Stage 3 shows the interest 1c earned from the advance 1b based on a time period at any suitable interest rate, or based on a lump sum for example 1c, or based on any other method.

Stage 4 shows the result 1d of the value 1d being the combined advance 1b and interest 1c. In this Stage 4 the value 1d, such as the product or service or money or anything else suitable is supplied to the payer by or on behalf of the supplier, when the value is reached, or at anytime after value is reached 1d.

The recurring point indicates the image or form of Stage 1 is the same or recurring as that of Stage 4. And the cycle repeats either with the same customer or with any other suitable customer/s.

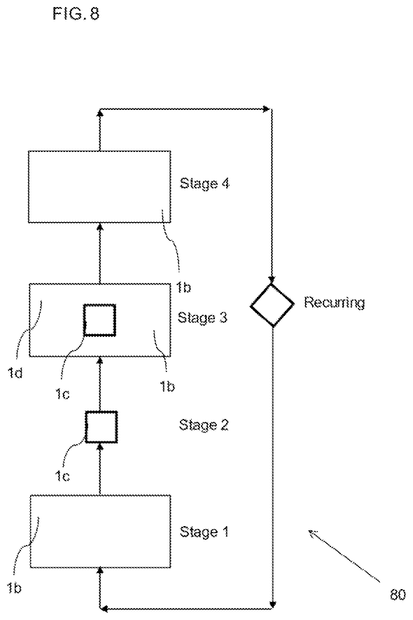

FIG. 8 shows a schematic diagram 80 of a method and a computer implemented method of an aspect of the invention. 80 shows the steps involved in the process or the mechanics of the Before Pay transaction system and method 80. This applies to all examples as shown herein in line with the system

$$a + i = v$$

Stage 1 shows 1b the advance made by a party to for example their own customer account 1b in a business. This is primarily with the intention to create credit on account from the payment 1b with a rolling balance that will increase with any applicable interest 1c. This can also be the case where the customer has not committed as to what to spend the money on while the credit is on account, although they may have an idea about that. The rolling balance may continue for a fixed term, or indefinitely, or to a charge out point where all or a portion of the balance is spent and where such would be considered as Stage 3.

Stage 2 shows the interest 1c earned on the advance

$$v - a$$

$$and$$

$$v - a = i$$

Stage 3 shows the result 1d of the value 1d being the combined advance 1b and interest 1c. In this Stage 3 the product or service or money or anything else suitable is supplied to the payer by or on behalf of the supplier.

Stage 4 shows the step of making an advance 1b either by the same payer or by any other customer/s. Note this recurs to start as Step 1.

Recurring point indicates the image or form of Stage 1 is the same or the recurring of Stage 4. And the cycle repeats either with the same payer or with any other suitable payer/s.

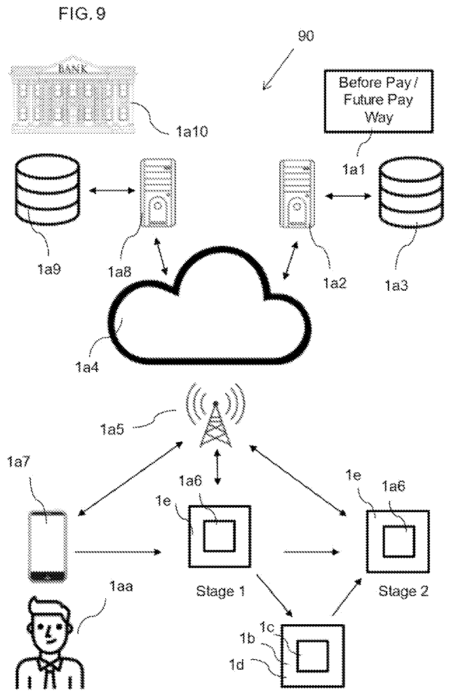

FIG. 9 is a system and method 90. This includes a method 90 and a computer implemented method 90. 1aa shows a customer with a mobile phone 1a7 connected by Wi-Fi 1a5 to the internet 1a4. The customer's 1aa mobile 1a7 is connected to a web site 1e store 1e. Also connected to the internet 1a4 is a bank 1a10 with one or more processors and or a server 1a8 and a data store 1a9. Optionally also connected to the internet 1a4 is the Before Pay 1a1 system also known as the Future Pay Way system 1a1 that includes one or more processors 1a2 and or a server 1a2 and a data store 1a3. Optionally the Future Pay Way 1a1-1a3 system can be directly incorporated or connected to the supplier 1e that is any provider such as a bank, store, merchant, web site, supplier, shop, or anything else suitable. The supplier 1e includes the Future Pay Way 1a1 system in line with the economic formula systems

$$a + i = v$$

$$or$$

$$v - i = a$$

Stage 1 shows the customer 1aa has an account 1a6 with the business 1e. The online account can be set up in the usual way of providing a username and a password. The customer 1aa deposits money 1b onto the account 1a6 by any known way such as via credit card or bank transfer. The payment 1b goes to the supplier 1e as the receiver 1f of the funds. The potential interest 1c together with the advance 1b is the potential value 1d. Stage 2 shows the account 1a6 has earned interest 1c after a period of time and the customer now has a balance of the advance 1b plus the interest 1c to the total of the value 1d. The customer 1aa can then buy goods and or services 1d or money or anything else suitable 1d from the business 1e or any affiliates 1e of the business 1e. The advance 1b plus the potential interest 1c is present at Stage 1. The advance 1b plus the interest 1c earned is present at Stage 2 forming the real value 1d. This payment system is a cooperative system that solves the poverty system (or the elements that can lead to poverty) by sustainable transactions or profit sharing which can include the business 1e passing on some of its profit to the customer 1aa that pays the interest portion 1c.

As an alternative the customer 1aa may or may not have an account 1a6 and can buy a virtual card 1a6 which is a local debit card in the sense that it can only be used with the business 1e or any approved affiliates of the business 1e. The card acts as an account 1a6 and earns interest 1c. The card can act as an account 1a6 and can work in a couple of different ways. At Stage 1 the customer 1aa buys a gift card 1a6 at a discount for example 25% off for the advance 1b with interest 1c (being the 25% discount portion) already loaded onto the card 1a6 but where the card is not active to be used until a later date, for example 12 months after the purchase date, so as to reflect a time period that the interest was earned. Stage 2 in this embodiment is when the card can be used because the interest 1c is earned, for example after the 12 month period as noted.

Another way the card 1a6 can be used is by the customer 1aa is by being purchased for the advance 1b price plus the interest 1c portion creating the total value price 1d. Stage 1 is the purchase stage in this example. The card 1a6 is not provided to the customer 1aa upon purchase but at a later date when the interest is earned. Alternatively the card 1a6 is provided upon the purchase but is not active then but is set to be active at a later date down the track. Stage 2 is when the customer 1aa can use their card 1a6 with the advance 1b and interest 1c earned on that card 1a6 of a total value amount 1d. This card has the right to have its value 1d redeemed by the supplier 1e or by any of its approved suppliers 1e.

The card 1a6 can be attached to a user account as part of the supplier 1e business like the way a credit card holder or debit card holder with a bank 1e works. Or the card 1dd can be stand-alone where it can be used without the need for a user account.

The method 90 will be further described by way of example. Customer 1aa by the name of Say Pay 1aa uses his smart phone 1a7 connected by Wi-Fi 1a5 to the internet 1a4 and searches the Amazon 1e web site www.amazon.com. Say 1aa sees a lot of interesting things including an underwater drone that does cost $725 USD. Say 1aa likes to see that Amazon 1e has Future Pay Way 90. It is advertised as “A local bank. Deposit your money here. Earn interest. And shop.” Say 1aa has an account 1a6 with Amazon 1e which he set up in the usual way by providing a username and password. Stage 1 sees Say 1aa deposit $1,000 into his Amazon 1e account 1a6. Amazon 1e pay 10% compound interest 1c per year to their customers 1aa. Stage 1 includes the potential interest 1c or amount of interest 1c that is not earned yet creating a potential value 1d. In 6 months Amazon 1e has paid $50 interest 1c onto Say's 1aa $1,000 in account 1a6 bring the total to $1,050. Stage 2 sees the advance 1b and interest 1c combined where the real total 1d at a given time is not a potential anymore but real balance to spend from the account 1a6 by Say 1aa as value 1d. Say decides to leave the balance another 6 months which brings the running total to $1,100. This follows the economic foundation in the local bank of

$$a + i = v$$

Also if Say 1aa had a final total goal in mind such as $1,100 (v) where he started with $1,000 balance (a) then we know the interest (i) portion is $100 at the 10% annually. This is in line with the formula

$$v - i = a$$

In this way whichever way Say 1aa may relay or portray his account 1a6 is a local bank account in a local bank 1e. This occurs whereby the local bank account 1a6 is an account 1a6 that is local to the bank 1e or where the funds from that account 1a6 can only be used on goods and or services or anything else suitable from or on behalf of the bank. In this case the bank 1e is Amazon 1e. So Say 1aa can use any of his account 1a6 money on goods and or services or anything else suitable on the Amazon 1e web site 1e or with any other businesses 1e or affiliates 1e approved of by Amazon 1e. Say 1aa buys the underwater drone on Amazon for $725 and has that delivered by air drone. Amazon 1e makes a 25% profit margin on the sale of $181.25. So the interest 1c paid to Say 1aa of $100 is less than the margin Amazon 1e made. So this Future Pay Way system 90 is sustainable and is a positive contribution to society by all parties involved including the customer 1aa, Amazon 1e, and the product supplier 1e (and any anyone else involved). This system 90 replaces the system of poverty with the system of wealth. Poverty in the sense that when anyone at any stage pays out an amount from a position that is not in profit means the payment is coming from a position of transfer that in an ultimate extreme can lead to poverty or an element of poverty or lack. Or at least be in connection with the elements essential in the formation of poverty. So in this way poverty is overwritten by wealth here 90.

Further embodiments will now be described by way of example in relation to a customer 1aa card 1a6 or virtual card 1a6 that acts like an account 1a6. On the Amazon 1e account 1a6 web site page 1e Say 1aa sees various Future Pay Ways advertised. These can be used by being connected to your Amazon 1e account 1a6 or they can be used as a stand-alone card without the need for an account with Amazon 1e. Here are some examples
1 $100 Card ready for use in 3 months cost $75
2 $300 Card ready for use in 6 months cost $250
3 $1,000 Card ready for use in 6 months cost $900
4 Create your Card. Enter deposit amount advance (a). Interest is 15% per annum. Based on the formula

$$a + i = v$$

5 Tailor your Card. Enter value (v) you want. Enter time period you are happy to wait before you can use your card. This uses the formula

$$v - i = a$$

The Amazon 1e web site has the Future Pay Way 1a1 system integrated into it so that it can sell cards ready for activation by a future set date. Or Amazon 1e can tailor any card for a buyer who does input the relevant details according to the system

$$v - i = a \\ or \\ a + i = v$$

In general Amazon 1e makes 15%-30%+profit margin for product sales. Also that means the overall margin for Amazon 1e per year is well over 25%. So this is above the interest rates Amazon 1e pays out for these Future Pay Way Cards 1a6 or accounts 1a6. So this system is profitable to Amazon 1e while making the customers 1aa happy and the sellers on Amazon 1e happy. Also most importantly while replacing poverty with wealth by this sustainable system and method. In the sense that no poverty can come out of this system 90 where payments are made only from a profitable position 90. Say 1aa uses his credit card via his bank 1a10 connected to the server 1a8 with data store 1a9 connected to the internet 1a4 connected to Amazon 1e, and pays for the $1,000 Card 1a6 that cost $900. Say 1aa does input his mobile number and email address to receive the virtual card 1a6. The payment advance 1b goes to Amazon 1e who is the receiver of the funds 1b. The interest portion of $100 is activated upon payment, but the card has start date of 6 months in the future. Stage 1 is the process of the customer 1aa buying the card 1a6 with potential interest 1c forming potential value 1d. This future date brings it to Stage 2. This is when the Card 1a6 can be used and Say 1aa has the balance of $1,000 made up of the advance 1b plus interest 1c making the value 1d on the card 1a6 connected to Amazon 1e also the receiver 1f. Say 1aa uses his mobile smart phone 1a7 in the same way he bought the card 6 months ago, connected to the internet 1a4 and Amazon 1e to now make a purchase with his card 1a6 account 1a6. Say 1aa finds the underwater drone 1d and makes the purchase of $725 by clicking on the drone, then at the checkout, entering the Card 1a6 number, or clicking on the virtual Card 1a6 in his email or text messages when prompted to do so, and the Card 1a6 number is read by Amazon 1e and funds from that account 1a6 is debited to make the purchase for the value (v). Delivery is free of charge by Amazon 1e by air drone. After Say 1aa received his drone (v) he set up an account 1a6 with Amazon 1e with a username and password. In his account details 1a6 is included his mobile and email which automatically links from those details the Card 1a6 to his account 1a6. His Future Pay Way 1a1 Card 1a6 balance on screen is $275. Redeemable when it suits Say 1aa. All the while Say 1aa could rest assured that his investment to buy the Card of $900 and the interest 1c were at all times backed by Amazon 1e product or services or money to redeem or equalize any debt in due course. In this way Amazon 1e gave security to the customer 1aa for the advance 1b or the load 1b of those funds from the customer 1aa to Amazon 1e. Or based on the time frame agreement made at the time of purchase or other time agreed on. A Swell way indeed for Amazon 1e, for Say 1aa, for the drone guys. A Swell way indeed thanks to Future Pay Way.

In another embodiment at Stage 1 Amazon 1e sells the Card 1a6 as a gift card at a discount where a virtual version is sent to the buyer on purchase but where its use date starts from a date in the future. So this Stage 1 includes the potential value 1d of the card 1a6 or account 1a6. Stage 2 is where the card 1a6 is activated, or where this is for use after an agreed time period where upon use it is for the full value 1d before it was discounted. Alternatively the Card is activated immediately but cannot buy or redeem anything of value until a set date in the future is reached where a time period as agreed is passed so that the interest 1c is earned in a fair way. For example a gift card cost $200. It is converted to a Future Pay Way Card by being discounted by 20% that is $40 and sold for $160 on the basis it can redeem good and or services or money to the value of $200 after 6 months. That is Stage 1 where the card 1a6 or account 1a6 includes potential value 1d. In Stage 2 the card can actually be used 1d as the interest 1c is earned and is ready to spend together with the advance 1b. In other embodiments any suitable figures or terms can be used. In this way the card is a localised credit card or localised debit card. Like a gift card, it has value that can be redeemed local to the provider or local to the business for which it is issued or local to the business or its affiliates for which it is designed. Like a credit card or debit card, it is like a bank account that earns interest and can be spent.

In another embodiment the provider 1e such as Amazon 1e sells the card 1a6 as a cross between a gift card and a credit card or debit card. The Gift Card 1a6 is converted into a Gift Credit Card by the Gift Card being sold at a discount as Stage 1 and where the card is to be supplied in the future after an agreed set time so that the advance 1b or the buy price earns expected interest 1c over that time creating expectant value 1d and when the card 1a6 is later provided it is then ready to use with its actual value 1d as Stage 2. For example a gift card cost $200. It is converted to a Future Pay Way 90 Card 1a6 by being discounted by 20% that is $40 and sold on 1 Jan. 2025 for $160 on the basis it will be delivered in a virtual form 6 months later on 1 Jul. 2025 to the buyer email address. That is Stage 1 where potential interest 1c is included in the format or value (v) of the card 1a6. By the 6 months that passes there is earned $40 in interest which brings the value (v) of the card to $200 ready for use. That is Stage 2. In other embodiments any suitable figures or terms can be used. In this way the card 1a6 is a localised credit card or localised debit card. Like a gift card, it has value that can be redeemed local to the provider or local to the business for which it is issued or designed for. Like a credit card or debit card, it is like a bank account that earns interest and can be spent.

With these cards 1a6 optionally there is an account 1a6 attached. If a customer chooses to set that up. The account 1a6 can be set up in the usual way with a username and password. The account for the Gift Card/Credit Card/Debit card works just like a bank account. Money can be deposited and withdrawn. A key distinction is that this Gift Card 1a6 earns interest, and is local to the provider of goods and or services or money or anything else suitable. Meaning a Gift Card for Amazon 1e has a balance that earns interest. And where the balance can be spent with any of Amazon 1e products for value (v) or sellers (v) or with any approved businesses 1e or parties 1e related to Amazon 1e. In this way the provider Amazon 1e backs up the monetary value in the account 1a6 or the card 1a6 with their goods or services or money or anything else suitable. This secures the balance on account. The money in an account 1a6 can earn interest in any suitable way. For example, 10% simple interest per annum, or 10% compound interest per annum, or 15% interest for a fixed term, or 30% interest for a fixed term, or 3%-50% interest for a fixed term. Or an interest rate earned monthly for example. Any other suitable interest terms or other terms and conditions may apply.

As can be seen this Future Pay Way method 90 of a local bank account 1a6 and this Future Pay Way method of a local bank 90 does demonstrate how positive and encouraging it is for a customer 1aa to be in alignment with the bank 1e who is the supplier 1e who also supports their product providers 1e. In this way the Future Pay Way method 90 solves the system of poverty by providing the system of positive cash flow and by being sustainable. By providing the system of cooperation and alignment. This creates the Future Pay Way system 90 where each person benefit and where the overall system benefits due to sustainability and positive growth all the while adding positive value to the society and the world around us. This Future Pay Way method 90 is designed to help people feel good, to feel better both individually and in their community. This Future Pay Way method 90 is designed to help people feel good, to feel better by providing material support with positive financial systems and being connected to an overall system where the parties involved are in alignment and on the same page. This creates a sense of purpose and belonging and positive value both in the current system and the world around us. In this way people in the world are helped to feel good by this invention in non-material terms and are helped materially to feel good at the same time.

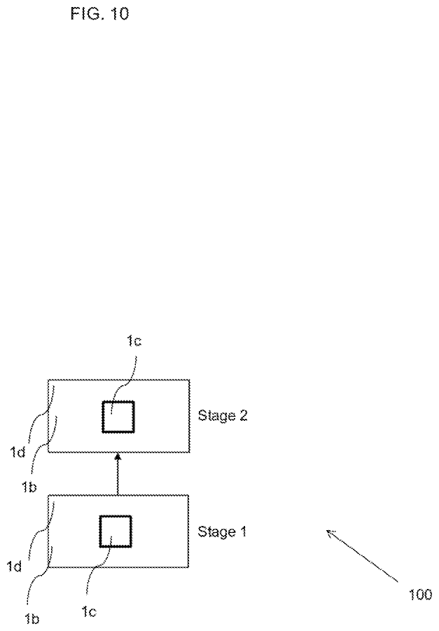

FIG. 10 shows a schematic diagram 100 of a method and a computer implemented method of an aspect of the invention. 100 shows the preferable steps involved in the process or the mechanics of the Before Pay transaction system and method or the Future Pay Way system and method 100. Preferably this applies to the 10 figures described herein. Preferably this is in line with the economic formulae

$$v - i = a \\ or \\ a + i = v$$

Stage 1 shows an advance 1b is made to a customer local bank account in a local bank. 1c shows potential interest earned on the advance 1b. 1d shows the value of the advance 1b plus the potential interest 1c.

Stage 2 shows the interest 1c earned

$$v - a$$

And the value 1d attained

$$a + i = v \\ or \\ v - a = i$$

Stage 2 shows that the interest made 1c is preferably paid from profit made or operating margin of the local bank or simply from being paid by the local bank from a profitable position or equivalent to a profitable position. Preferably this means the interest component 1c is a flow through from the local bank to the customer via the local bank account. Preferably this flow through means being a core element that creates alignment between the parties and sustainability for the payment process making the system positive to all people involved with long term sustainability for the community and the world around us.

The structure of the system in Stage 1 being made up of the advance 1b the potential interest 1c and the value 1d is the same structure of the system in Stage 2. This is because all elements of the advance 1b the interest 1c and the value 1d are the same in both Stages. The difference between Stage 1 and Stage 2 is the interest 1c component which is made real preferably by the flow through of the profit share or equivalent to that of the local bank with the local bank account and in turn the customer.

The interest component 1c made real is preferably because the customer made the advance 1b in order to be part of the profit share system that would unfold at a later date. In this way preferably the advance 1b creates the alignment of the profit share of the interest 1c that is to later follow.

Preferably the alignment of the local bank with the local bank account and in turn the customer, is created by the local bank obtaining the advance 1b and having the ability to use that advance 1b in their bank, and make profit, and at a later date pay the advance and a portion of profit or equivalent to that, to the customer.

Preferably in this way Stage 1 and Stage 2 show that the customer with their local bank account is in alignment with the local bank where they both benefit from the system by feeling more connected and being the same direction, and where they both financially benefit. As this values people on the ground level this helps people individually and as a community, as a result contributing to the world around us.

For all of the figures and drawings the system and method of the inventions can include any combination or permutation of the elements and principles of design (as are known in the design industry) used for any given embodiment, or any range of embodiments.

The following paragraphs below are quoted from patent U.S. Pat. No. 9,268,820B2. Those paragraphs are quoted because they well describe common or public material as to how computing systems or computer implemented methods or computer implemented systems and methods are implemented. That applies to each aspect of the invention in patent U.S. Pat. No. 9,268,820B2 and also to each aspect of the invention in this document and to each embodiment of the invention in this document. This quote is provided to be incorporated in full as part of this specification, showing known systems that implement each aspect of the invention in this document and each embodiment of the invention in this document. Credit for authorship and any possible copyright for those quotes are hereby acknowledged as vesting in patent holder of patent U.S. Pat. No. 9,268,820B2, or whoever they have provided that to.

Begin quote from patent U.S. Pat. No. 9,268,820B2:

“Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively, or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (Held programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.”

End of quote from patent U.S. Pat. No. 9,268,820B2.

In all aspects of the invention and in all preferred embodiments of the invention, and yet in other aspects of invention and yet in other preferred embodiments of the invention, there can be any suitable design specifications, structure or architecture, including with related components or parts, items or things, in any suitable number or quantity, to be used in line with the spirit and scope of the inventions.

Since modifications within the spirit and scope of the invention may readily be affected by persons skilled within the art, it is to be understood that this invention is not limited to the particular embodiments described by way of example hereinabove.

What is claimed is:

1. A method comprising:
one or more processors configured to perform operations including:
a transaction system wherein value (v) is paid for by the advance (a) that is value less interest (i) wherein the advance earns interest leading to the delivery of the value by the advance and the interest
$$v - i = a .$$

2. The method of claim 1, wherein for example
$$v - i = a$$
$300−$50=$250

3. The method of claim 1, wherein a first party advances funds to a second party as part payment for the value and wherein interest is either a lump sum or is earned from the advance wherein interest plus the advance equal the value wherein the second party provides the value or has the value provided then to the first party.

4. The method of claim 1, wherein the value can be in the form of goods or services, or money, or anything else suitable.

5. A method of claim 1, implemented by any of the following systems 5 (a) through 5 (e):
a. A method performed by data processing apparatus, the method comprising:
b. A computer storage medium encoded with a computer program, the program comprising instructions that when executed by data processing apparatus cause the data processing apparatus to perform operations comprising:
c. A system comprising:
i. A data store for storing content items; and
ii. One or more processors configured to interact with the data store, the one or more processors being further configured to perform operations comprising:
d. A computer implemented method comprising:
one or more processors configured to perform operations including:
e. A method comprising:
one or more processors configured to perform operations including:

6. A method comprising:
one or more processors configured to perform operations including:
a transaction system wherein value (v) is paid for by for the advance (a) plus interest (i) leading to the delivery of the value
$$a + i = v .$$

7. The method of claim 6, wherein for example
$$a + i = v$$
$250+$50=$300

8. The method of claim 6, wherein the transaction system is part of a business, or store, or bank, or any other organization and where
$$a + i + n = v$$
$250+$50+$5=$305
$$a + i = v - n$$
$250+$50=$305−$5

9. The method of claim 8, wherein n is a number representing a fee or transaction fee.

10. A method comprising:
one or more processors configured to perform operations including:
a method of Pay Sys, as in a method of a payment system;
including a customer account with a business or supplier;
wherein funds are applied to the business or supplier customer account that earns interest or potential interest, or theoretical interest, or a discount, or right for one or more discounts, payable by the business or supplier;
wherein the business as the receiver of the funds can use the advance in the operations of the business; and
wherein the business or supplier settles the transaction in line with the method of
$$v = a + i \\ where \\ value ( v ) = advance ( a ) + interest or discount ( i )$$
by supplying to the customer goods and or services or money or anything else applicable.

11. The method of claim 10, wherein the business or receiver settles the transaction from resources first received in their business operations.

12. The method of claim 10, wherein the business or receiver makes its money or profit margin or operating margin from the sale of good and or services.

13. The method of claim 10, wherein the settlement of the transaction means the advance and the interest portion or potential interest portion, or theoretical interest portion, or discount portion, have been provided to the customer in the form of goods and or services or money or anything else suitable, which is preferably at a later date from when the advance was made.

14. The method of claim 10, wherein the payment system is a profit share system, in the sense that the business or operation settles the transaction from its operating function of selling goods and or services or anything else suitable, either from operations in general, or from operations to do with another transaction, or with the operation specifically related to the transaction with the specific customer.

15. The method of claim 10, wherein the Pay Sys, or the payment system is in line with the following formulae
$$a + i = v \\ and or$$
$$v - i = a .$$

16. The method of claim 1, wherein known systems and methods, apparatuses, articles, items or things can be used to implement all aspects of the invention and all embodiments and preferred embodiments of the invention.

17. The method of claim 1, wherein any combination or permutation of the elements and principles of design (as are known in the design industry) are used for any given embodiment, or any range of embodiments.

18. The method of claim 1, wherein any combination or permutation of any number of claims can be made with any number of other claims, creating the definition of new claims.

19. The method of claim 1, wherein the system and method as represented or described in any part of this specification.

20. The method of claim 1, wherein the system and method as represented or described in any part of the figures or drawings.
